(19) United States
(12) Patent Application Publication
(10) Pub. No.: US 2022/0101219 A1
(43) Pub. Date: Mar. 31, 2022

(54) SYSTEM AND METHOD FOR OPTIMIZING ENERGY OBTAINED FROM RENEWABLE SOURCES

(71) Applicant: Solarlytics, Inc., Livermore, CA (US)

(72) Inventor: Son H. Nguyen, St. Paul, MN (US)

(21) Appl. No.: 17/483,625

(22) Filed: Sep. 23, 2021

Related U.S. Application Data
(60) Provisional application No. 63/084,489, filed on Sep. 28, 2020.

(51) Int. Cl. G06Q 10/06; H02J 3/38; G06Q 50/06

(52) U.S. Cl. CPC G06Q 10/0633; H02J 3/381; H02J 2300/28; H02J 2300/26; G06Q 50/06

(57) ABSTRACT

A system for optimizing energy obtained from at least one energy source and methods for making and using the same. By monitoring an operating environment of the energy source and an operational status of the energy source itself, the energy optimization system establishes and maintains an operating region of the energy source to optimize the energy supplied by the energy source and adjusts the operating region, as needed, for adapting to any changes in the operating environment or the operational status in real time. The energy optimization system thereby can enable the energy source to continuously operate at new peak efficiency and power. A supplemental control system can provide enhanced monitoring, commanding, and controlling for the energy optimization system. The energy optimization system advantageously can be utilized to optimize the energy obtained from renewable energy sources, such as solar, wind, tidal and thermal energy sources.

### CROSS-REFERENCE TO RELATED APPLICATIONS

This application claims the benefit of, and priority to, U.S. Provisional Application Ser. No. 63/084,489, filed Sep. 28, 2020, the disclosure of which is hereby incorporated herein by reference in its entirety and for all purposes.

### FIELD

The disclosed embodiments relate generally to energy generation systems and more particularly, but not exclusively, to systems and methods for optimizing energy obtained from renewable energy sources, such as solar, wind, tidal and thermal energy sources.

### BACKGROUND

A tremendous amount of solar energy irradiates the earth's surface each day. In fact, the solar energy striking the earth in ninety minutes is equivalent to what the world consumes in one year. Harvesting this energy is of great interest since the source of energy is ever present and available.

Multiple conventional methods exist for converting solar energy to electricity. One method involves concentrating light though mirrors and lenses and then converting the concentrated light to thermal energy, which is used to heat water and produce steam. The steam is, in turn, used to drive a generator to produce electricity.

Another more typical method of converting solar energy into electricity is through a solar cell, which directly converts sunlight into electricity. When light strikes the solar cell, photonic energy is transferred to electrons that flow through the solar cell to make electricity. The amount of electricity produced is dependent on many factors to include the wavelength of the light, incident angle, temperature, reflection of light off the solar cell, and recombination—a non-desirable process of electrons colliding with a “holes.”

These conventional solar energy conversion methods are not without pitfalls. In stable irradiance, a determination of peak power requires multiple trial and error attempts that will occur over time. During the search for peak power, potential power is lost because the solar cell is not at the peak power point. If the time spent at each of the three points, initial, low, and high voltage is equal, for example, the solar cell is not on peak power during at least two-thirds of the time. No time is spent at peak power if none of the points represent peak power.

In practice, irradiance is never stable and constantly changes as the sun passes overhead. As a result, the trial-and-error process must continually operate. Furthermore, changing atmospheric conditions to include overcast, wind, changes in temperature, and potential variances in solar spectrum can cause unexpected and dramatic variances on the peak power operating point. The consequences are a loss in power because the solar cell will rarely be at the peak operating point due the latency of the trial-and-error process.

In view of the foregoing, a need exists for an improved system and method for optimizing energy that overcomes the aforementioned obstacles and deficiencies of currently-available energy generation systems.

### BRIEF DESCRIPTION OF THE DRAWINGS

FIG. 1A is a top-level block diagram illustrating an exemplary embodiment of an energy optimization system for optimizing energy obtained from at least one energy source.

FIG. 1B is a top-level block diagram illustrating an alternative exemplary embodiment of the energy optimization system for FIG. 1A, wherein a selected energy source comprises a photovoltaic device.

FIG. 2A illustrates exemplary current-voltage characteristic curves of the photovoltaic device of FIG. 1B for different intensities of light incident on the photovoltaic device.

FIG. 2B illustrates exemplary current-voltage characteristic curves of the photovoltaic device of FIG. 1B for different temperatures in an operating environment associated with the photovoltaic device.

FIG. 3A illustrates exemplary power-voltage characteristic curves of the photovoltaic device of FIG. 1B for different intensities of light incident on the photovoltaic device.

FIG. 3B illustrates exemplary power-voltage characteristic curves of the photovoltaic device of FIG. 1B for different temperatures in an operating environment associated with the photovoltaic device.

FIG. 4 is a top-level block diagram illustrating another alternative exemplary embodiment of the energy optimization system of FIGS. 1A-B, wherein the energy optimization system includes a control system for establishing, maintaining and/or adjusting an operating region of each respective energy source.

FIG. 5A is a detail diagram illustrating an exemplary embodiment of the energy conversion system of FIG. 4, wherein the energy conversion system generates output power based upon electrical energy received from the energy source.

FIG. 5B is a detail diagram illustrating an exemplary embodiment of a sensor system for providing one or more sensor signals to convey measurement information about the operating environment associated with the energy source and/or the operational status of the energy source to the control system of FIG. 4.

FIG. 5C is a detail diagram illustrating an exemplary embodiment of the control system of FIG. 4.

FIG. 6A is a top-level flow chart illustrating an exemplary embodiment of an energy optimization method performed by the control system of FIG. 4.

FIG. 6B is a top-level flow chart illustrating an exemplary alternative embodiment of the energy optimization method of FIG. 6A, wherein the method includes calculating quantitative model parameters.

FIG. 7A is a top-level block diagram illustrating an alternative exemplary embodiment of the energy optimization system of FIG. 4, wherein the energy optimization system includes a supplemental control system for monitoring, commanding, and/or controlling the energy optimization system.

FIG. 7B is a top-level block diagram illustrating an alternative exemplary embodiment of the energy optimization system of FIG. 7A, wherein the energy optimization system includes a user computer system.

FIG. 8 is a detail diagram illustrating an exemplary embodiment of the supplemental control system of FIGS. 7A-B.

FIG. 9 is a detailed flow chart illustrating another exemplary alternative embodiment of the energy optimization methods of FIGS. 6A-B.

FIGS. 10A-C are a detailed flow chart illustrating an exemplary alternative embodiment of the energy optimization methods of FIG. 9.

FIG. 11 is a detailed flow chart illustrating an exemplary embodiment of a first interaction method by which the supplemental control system of FIGS. 7A-B interacts with the control system of FIG. 4.

FIGS. 12A-D are a detailed flow chart illustrating an exemplary embodiment of a machine learning method for the supplemental control system of FIGS. 7A-B.

FIGS. 13A-C are a detail drawings illustrating exemplary data arrays of the supplemental control system of FIGS. 7A-B.

FIG. 14 is a detailed flow chart illustrating an exemplary embodiment of a second interaction method by which the supplemental control system of FIGS. 7A-B interacts with the user computer system of FIG. 7B.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

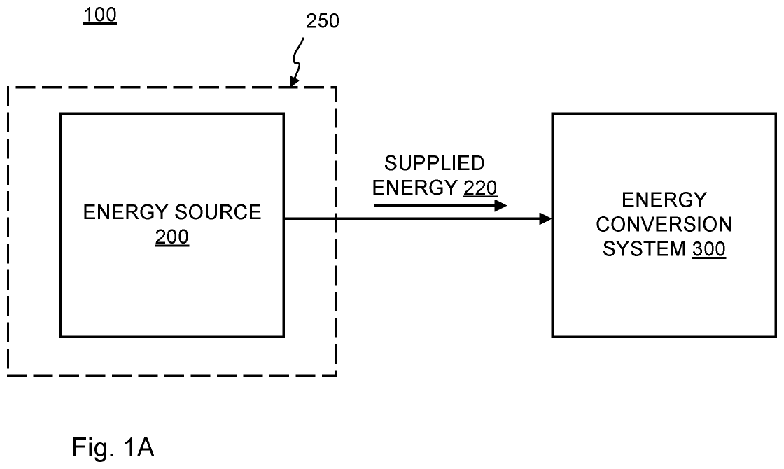

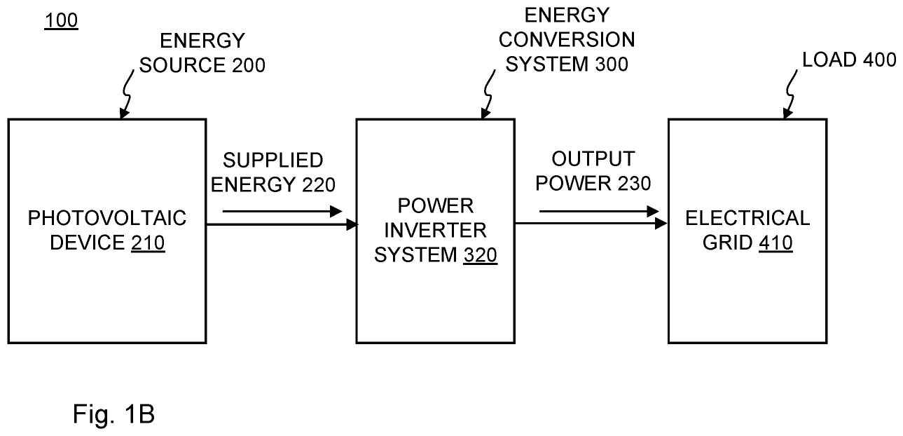

Since currently-available methods for attempting to maximize power output from energy sources use a trial-and-error approach, rarely operate at peak power and are unable to rapidly respond to operational and environmental changes, a system and method for optimizing energy that overcomes these shortcomings can prove desirable and provide a basis for a wide range of system applications, including optimizing energy obtained from renewable energy sources, such as solar, wind, tidal and/or thermal energy sources. This result can be achieved, according to selected embodiments disclosed herein, by an energy optimization system 100 as illustrated in FIGS. 1A-B.

Turning to FIG. 1A, the energy optimization system 100 is shown as comprising an energy conversion circuit (or system) 300 for communicating with one or more energy sources 200 that supply energy 220, such as a supplied electrical voltage, current and/or power. The energy conversion system 300 can receive the supplied energy 220 from the energy sources 200 in any conventional manner. The energy sources 200, for example, can provide the supplied energy 220 to the energy conversion system 300 via a wireless transmission system (not shown) and/or a wired transmission system (not shown) that includes one or more cables. The energy conversion system 300 can generate output power 230 (shown in FIG. 1B), such as an output voltage and/or an output current, based upon the received supplied energy 220. Stated somewhat differently, the energy sources 200 can contribute to the generated output power 230.

The energy sources 200 can be distal from, and/or proximal to, the energy conversion system 300. Stated somewhat differently, the energy conversion system 300 can be at least partially (or completely) disposed within an operating environment 250 of at least one of the energy sources 200 and/or can be remote from the operating environment 250. In selected embodiments, one or more of the energy sources 200 can be associated with a common operating environment 250 and/or the energy sources 200 can be dispersed among a plurality of separate operating environments 250. A first operating environment 250 can be proximal to a second operating environment 250 and/or distal from a third operating environment 250.

Advantageously, the energy optimization system 100 can maximize or otherwise optimize the supplied energy 220 provided by each energy source 200, preferably in real-time. The energy optimization system 100, for example, can establish and/or maintain an operating point (or region) of each respective energy source 200 to optimize the supplied energy 220 provided by the energy source 200. In selected embodiments, the energy optimization system 100 optionally can adjust the operating region, as needed, for adapting to one or more environmental changes in the operating environment 250 of a relevant energy sources 200 and/or one or more operational changes to the energy source 200 itself. The energy optimization system 100 thereby can enable the energy source 200 to continuously operate at (or very near) peak efficiency and/or peak power. Stated somewhat differently, the energy optimization system 100 advantageously can enable the energy source 200 to instantaneously achieve (or very near) peak efficiency and/or peak power without any searching via a trial-and-error methodology or any associated loss of power.

Each energy source 200 can comprise an energy source of any conventional type and, in selected embodiments, can include a renewable energy source, such as a solar energy source, a wind energy source, a tidal energy source and/or a thermal energy source, without limitation. Exemplary wind energy sources can include an electrical generator (not shown) for being driven by wind; whereas, an electrical generator (not shown) for being actuated by tidal change can be an exemplary tidal energy source. As illustrated with reference to the exemplary energy optimization system 100 of FIG. 1B, for example, the energy source 200 can comprise a photovoltaic device 210. Exemplary photovoltaic devices 210 can comprise a solar cell, an array of solar cells, a solar panel, and/or an array of solar panels, etc., for receiving solar energy and converting the received solar energy into the supplied energy 220.

The array of solar cells, for example, can comprise a plurality of solar cells that are arranged in a predetermined solar cell configuration. The predetermined solar cell configuration can include, but is not limited to, a parallel arrangement of solar cells and/or a series arrangement of solar cells. Additionally and/or alternatively, the array of solar panels can comprise a plurality of solar panels that are arranged in a predetermined solar panel configuration. The predetermined solar panel configuration can include a parallel arrangement of solar panels and/or a series arrangement of solar panels, without limitation.

The conversion system 300 optionally can provide the generated output power 230 to a load 400 as shown in FIG. 1B. An exemplary loads 400 can comprise, but is not limited to, an electrical grid 410. The energy conversion system 300 can receive the supplied energy 220 from the photovoltaic device 210 and, as needed, convert the received supplied energy 220 into the output power 230 with a form that is suitable for use by the load 400. For example, the energy conversion system 300 optionally can include at least one power inverter 320 for converting direct current (or DC) electrical energy provided by the photovoltaic device 210 into alternating current (or AC) electrical energy for use by the load 400. An amplitude, a frequency, a duty cycle, a phase, a number phases and/or other characteristics of the alternating current electrical energy can be based upon country, regional or other local requirements for electrical energy.

In selected embodiments, the energy conversion system 300 can provide the output power 230 with more than one output voltage and/or with more than one output current to a particular load 400. The energy conversion system 300, additionally and/or alternatively, can provide the output power 230 to more than one load 400. The output power 230 can be uniform and/or different among the loads 400. For example, the energy conversion system 300 can generate a first output voltage with a first output current and a second output voltage with a second output current. The energy conversion system 300 thereby can provide the first and second output voltages to a first load 400 and/or can provide the first output voltage to a second load 400 and the second output voltage to a third load 400, without limitation.

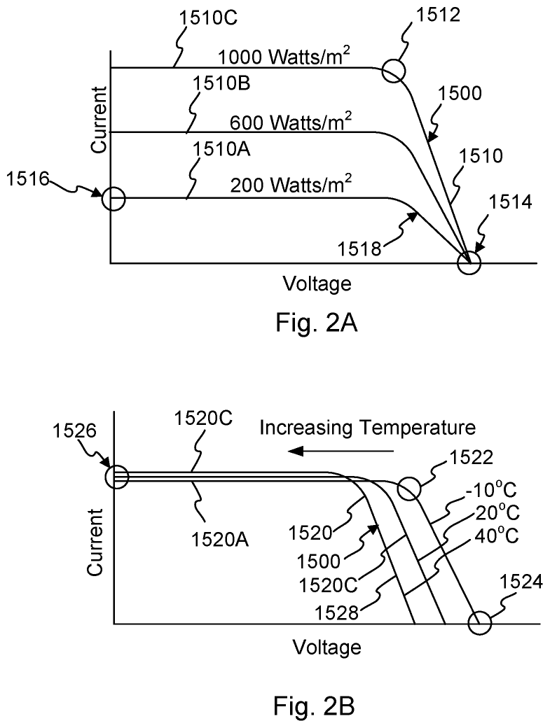

Each energy source 200 can have one or more source characteristics. The source characteristics can be set forth in one or more characteristic curves 1500. The source characteristics can be uniform and/or different among the different types of energy sources 200. Exemplary characteristic curves 1500 for a photovoltaic device 210 (shown in FIG. 1B) are illustrated in FIGS. 2A-B and 3A-B. Turning to FIG. 2A, for example, the characteristic curves 1500 can include at least one current-voltage characteristic curve 1510. The current-voltage characteristic curve 1510 can illustrate a relationship between the current and the voltage supplied by the photovoltaic device 210. As shown in FIG. 2A, the current-voltage characteristic curve 1510 can be depicted on a graph with an x-axis being associated with voltage and a y-axis being associated with current.

The current-voltage characteristic curves 1510 of FIG. 2A illustrate the current-voltage characteristic of the photovoltaic device 210 with predetermined number of source characteristics being adjustable or otherwise variable while one or more other source characteristics of the photovoltaic device 210 are maintained at fixed (or constant) levels. The predetermined number of variable source characteristics preferably comprises a small (or limited) number and, in selected embodiments, can comprise one variable source characteristic.

The supplied current and supplied voltage relationship of the photovoltaic device 210, for instance, can change based upon an intensity of light incident on the photovoltaic device 210. An increased intensity of the light incident on the photovoltaic device 210 can result in an increased supplied current level for the photovoltaic device 210. An exemplary current-voltage characteristic of the photovoltaic device 210 is shown in FIG. 2A for a selected intensity of the light incident on the photovoltaic device 210 with each other source characteristic, such as an operating temperature, of the photovoltaic device 210 being maintained at a constant level. Stated somewhat differently, each of the current-voltage characteristic curves 1510 is shown for a predetermined (solar) irradiance when the photovoltaic device 210 is disposed in an operating environment 250 (shown in FIG. 1A) with the preselected fixed temperature.

FIG. 2A illustrates three exemplary current-voltage characteristic curves 1510A-C of the photovoltaic device 210 for three different selected intensities of light incident on the photovoltaic device 210. As shown in FIG. 2A, supplied current levels associated with the first current-voltage characteristic curve 1510A for a selected first radiance of 200 watts per square meter can be less than supplied current levels associated with the second current-voltage characteristic curve 1510B for a selected second radiance of 600 watts per square meter. The supplied current levels associated with the second current-voltage characteristic curve 1510B for the selected second radiance of 600 watts per square meter likewise are illustrated as being less than the supplied current levels associated with the third current-voltage characteristic curve 1510C for a selected second radiance of 1000 watts per square meter.

Each current-voltage characteristic curve 1510A-C is illustrated as having a slope 1518 that is equal to approximately zero until an inflection point (or region) 1512 of the current-voltage characteristic curve 1510 is reached. After the inflection region 1512, the slope 1518 is shown as becoming steeply negative. A change in the slope 1518 of the current-voltage characteristic curve 1510 can occur for a variety of irradiances.

The current-voltage characteristic curves 1510 can include an open circuit voltage 1514 and/or a short circuit current 1516. The open circuit voltage 1514 can comprise a voltage at which the current-voltage characteristic curve 1510 intersects the x-axis. Stated somewhat differently, the supplied current of the photovoltaic device 210 can be equal to zero at the open circuit voltage 1514. The short circuit current 1516 can comprise a current at which the current-voltage characteristic curve 1510 intersects the y-axis. The supplied voltage of the photovoltaic device 210, in other words, can be equal to zero at the short circuit current 1516.

Additional characteristic curves 1500 of the photovoltaic device 210 (shown in FIG. 1B) are shown in FIG. 2B. The characteristic curves 1500 of FIG. 2B can include at least one other current-voltage characteristic curve 1520 of the photovoltaic device 210 (shown in FIG. 1B) and can illustrate an alternative relationship between the supplied current and the supplied voltage of the photovoltaic device 210. In the manner set forth with reference to FIG. 2A, the current-voltage characteristic curves 1520 are shown as being depicted on a graph with an x-axis being associated with voltage and a y-axis being associated with current.

In the manner set forth above with regard to the current-voltage characteristic curves 1510 of FIG. 2A, the current-voltage characteristic curves 1520 of FIG. 2B illustrate the current-voltage characteristic of the photovoltaic device 210 with predetermined number of source characteristics being adjustable or otherwise variable while one or more other source characteristics of the photovoltaic device 210 are maintained at fixed (or constant) levels. The supplied current and supplied voltage relationship of the photovoltaic device 210 can change based upon at least one environmental change in an operating environment 250 (shown in FIG. 1A) of the photovoltaic device 210.

In selected embodiments, an increased operating temperature can result in an increased supplied current level for the photovoltaic device 210. The exemplary current-voltage characteristic curve 1520 of FIG. 2B is shown for a selected operating temperature with each other source characteristic, such as an intensity of incident light, of the photovoltaic device 210 being maintained at a constant level. In other words, the current-voltage characteristic curve 1520 is illustrated for the photovoltaic device 210 when exposed to a constant irradiance.

FIG. 2B illustrates three exemplary current-voltage characteristic curves 1520A-C of the photovoltaic device 210 for three different selected operating temperatures. As shown in FIG. 2B, each current-voltage characteristic curve 1520 can have a slope 1528 that is equal to approximately zero until an inflection point (or region) 1522 is reached. After the inflection region 1522, the slope 1528 is shown as becoming steeply negative. Each current-voltage characteristic curve 1520 can include an open circuit voltage 1524 and/or a short circuit current 1526. The open circuit voltage 1524 can comprise a voltage at which the current-voltage characteristic curve 1520 intersects the x-axis. Stated somewhat differently, the supplied current of the photovoltaic device 210 can be equal to zero at the open circuit voltage 1524. The short circuit current 1526 can comprise a current at which the current-voltage characteristic curve 1520 intersects the y-axis. The supplied voltage of the photovoltaic device 210, in other words, can be equal to zero at the short circuit current 1526.

The one or more operating characteristics of the photovoltaic device 210 can change as the operating temperature changes. As the operating temperature increases, the inflection region 1522, the short circuit current 1526 and/or the open circuit voltage 1524 for the current-voltage characteristic curve 1520 can shift as illustrated in FIG. 2B. The short circuit current 1526, for example, can increase (or decrease) as the operating temperature increases (or decreases). Additionally and/or alternatively, the inflection region 1522 and the open circuit voltage 1524 for the first current-voltage characteristic curve 1520A for a selected temperature of −10° C. are shown as being to right of the inflection region 1522 and the open circuit voltage 1524 for the second current-voltage characteristic curve 1520B, respectively, for a selected temperature of 20° C. The inflection region 1522 and the open circuit voltage 1524 for the second current-voltage characteristic curve 1520B for the selected temperature of 20° C. similarly are illustrated as being to right of the inflection region 1522 and the open circuit voltage 1524 for the third current-voltage characteristic curve 1520C, respectively, for a selected temperature of 40° C.

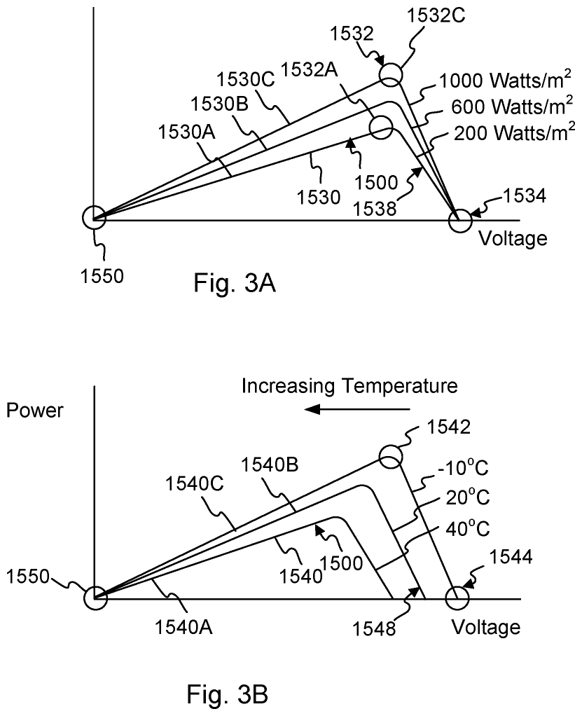

Additionally and/or alternatively, graphs for one or more other characteristics of the energy source 200 can be generated. The characteristic curves 1500, for example, can include at least one power-voltage characteristic curve of the energy source 200 (shown in FIG. 1A). Exemplary power-voltage characteristic curves 1530, 1540 as shown in FIGS. 3A-B can illustrate a relationship between supplied power and supplied voltage of the photovoltaic device 210 (shown in FIG. 1B). The relationship between the supplied power and the supplied voltage of the photovoltaic device 210 can be based at least in part upon the relationship between the supplied current and the supplied voltage of the photovoltaic device 210 as discussed in more detail above with reference to FIGS. 2A-B.

FIGS. 3A-B illustrate that the power-voltage characteristic curves 1530, 1540 can be depicted on a graph with an x-axis being associated with voltage and a y-axis being associated with power. The power-voltage characteristic curves 1530, 1540 illustrate the power-voltage characteristic of the photovoltaic device 210 with predetermined number of source characteristics being adjustable or otherwise variable while one or more other source characteristics of the photovoltaic device 210 are maintained at fixed (or constant) levels. The predetermined number of variable source characteristics preferably comprises a small (or limited) number and, in selected embodiments, can comprise one variable source characteristic.

Turning to FIG. 3A, for example, the supplied power and supplied voltage relationship of the photovoltaic device 210 can change based upon an intensity of the light incident on the photovoltaic device 210. An increased intensity of the light incident on the photovoltaic device 210 can result in an increased supplied power level for the photovoltaic device 210. An exemplary power-voltage characteristic of the photovoltaic device 210 is shown in FIG. 3A for a selected intensity of the light incident on the photovoltaic device 210 with each other source characteristic, such as an operating temperature, of the photovoltaic device 210 being maintained at a constant level. Stated somewhat differently, the power-voltage characteristic curve 1530 is shown for a predetermined irradiance when the photovoltaic device 210 is disposed in an operating environment 250 (shown in FIG. 1A) with the preselected fixed temperature.

FIG. 3A illustrates three exemplary power-voltage characteristic curves 1530A-C of the photovoltaic device 210 for three different selected intensities of light incident on the photovoltaic device 210. As shown in FIG. 3A, the supplied power levels associated with the first power-voltage characteristic curve 1530A for a selected first radiance of 200 watts per square meter can be less than the supplied power levels associated with the second power-voltage characteristic curve 1530B for a selected second radiance of 600 watts per square meter. The supplied power levels associated with the second power-voltage characteristic curve 1530B for the selected second radiance of 600 watts per square meter likewise can be less than the supplied power levels associated with the third power-voltage characteristic curve 1530C for a selected second radiance of 1000 watts per square meter.

Each power-voltage characteristic curve 1530 can include an open circuit voltage 1534. The open circuit voltage 1534 can comprise a voltage at which the power-voltage characteristic curve 1530 intersects the x-axis. Stated somewhat differently, the supplied power of the photovoltaic device 210 can be equal to zero at the open circuit voltage 1534. Each respective power-voltage characteristic curve 1530 presents a slope 1538 that is positive between an ordinate (or origin) 550 of the graph and an inflection point (or region) 1532 of the power-voltage characteristic curve 1530. At the inflection region 1532, the slope 1538 becomes negative until the open circuit voltage 1534 is reached.

Additionally and/or alternatively, the supplied power and supplied voltage relationship of the photovoltaic device 210 can change based upon an operating environment 250 (shown in FIG. 1A) of the photovoltaic device 210. In selected embodiments, an increased operating temperature can result in a decreased supplied power level for the photovoltaic device 210. The exemplary power-voltage characteristic curves 1540 of FIG. 3B are shown for selected operating temperatures with each other source characteristic, such as an intensity of incident light, of the photovoltaic device 210 (shown in FIG. 1B) being maintained at a constant level. In other words, the power-voltage characteristic curves 1540 are illustrated for the photovoltaic device 210 when exposed to a constant irradiance.

FIG. 3B illustrates three exemplary power-voltage characteristic curves 1540A-C of the photovoltaic device 210 for three different selected operating temperatures. As shown in FIG. 3B, the supplied power levels associated with the first power-voltage characteristic curve 1540A for a selected temperature of −10° C. can be less than the supplied power levels associated with the second power-voltage characteristic curve 1540B for a selected temperature of 20° C. The supplied power levels associated with the second power-voltage characteristic curve 1540B for the selected temperature of 20° C. likewise can be less than the supplied power levels associated with the third power-voltage characteristic curve 1540C for a selected temperature of 40° C.

Each power-voltage characteristic curve 1540A-C can include an open circuit voltage 1544. The open circuit voltage 1544 can comprise a voltage at which the power-voltage characteristic curve 1540 intersects the x-axis. In other words, the supplied power of the photovoltaic device 210 can be equal to zero at the open circuit voltage 1544. Each respective power-voltage characteristic curve 1540 presents a slope 1548 that is positive between an ordinate (or origin) 550 of the graph and an inflection point 1542 of the power-voltage characteristic curve 1540. At the inflection point 1542, the slope 1548 becomes negative until the open circuit voltage 1544 is reached. Although shown and described with reference to FIGS. 2A-B and 3A-B as including current-voltage characteristic curves and power-voltage characteristic curves for a photovoltaic device 210 for purposes of illustration only, the characteristic curves 1500 can include one or more graphs for any preselected source characteristics of any predetermined type of energy source 200 without limitation.

The energy optimization system 100 of FIGS. 1A-B advantageously can account for variations, including temperature changes, in the operating environment 250 of the photovoltaic device 210 or other energy source 200 to establish and/or maintain the operating region of the energy source 200. The energy optimization system 100, for example, can account for the variations in the operating environment 250 of the energy source 200 in a direct manner and/or in an indirect manner. In selected embodiments, the energy optimization system 100 can find and/or track peak efficiency and/or peak power of the energy source 200 based at least in part on variations, such as temperature and/or irradiance variations, within the operating environment 250 of the energy source 200.

With reference to the power-voltage characteristic curves 1530A-C illustrated in FIG. 3A, for example, if the operating region of the photovoltaic device 210 is set to the inflection region 1532C of the third power-voltage characteristic curve 1530C and the irradiance at the photovoltaic device 210 changes from 1000 watts per square meter to 200 watts per square meter, the energy optimization system 100 advantageously can adjust the operating region of the photovoltaic device 210 to the inflection region 1532A of the first power-voltage characteristic curve 1530A that corresponds to an irradiance of 200 watts per square meter. The energy optimization system 100, in other words, can shift the operating region of the photovoltaic device 210 from the inflection region 1532C of the third power-voltage characteristic curve 1530C to the inflection region 1532A of the first power-voltage characteristic curve 1530A. The energy optimization system 100 thereby can establish and/or maintain the operating region for enabling the energy source 200 to continuously operate at (or very near) peak efficiency and/or peak power regardless of variations in the operating environment 250 of the energy source 200 and/or variations in the operational status of the energy source 200 itself.

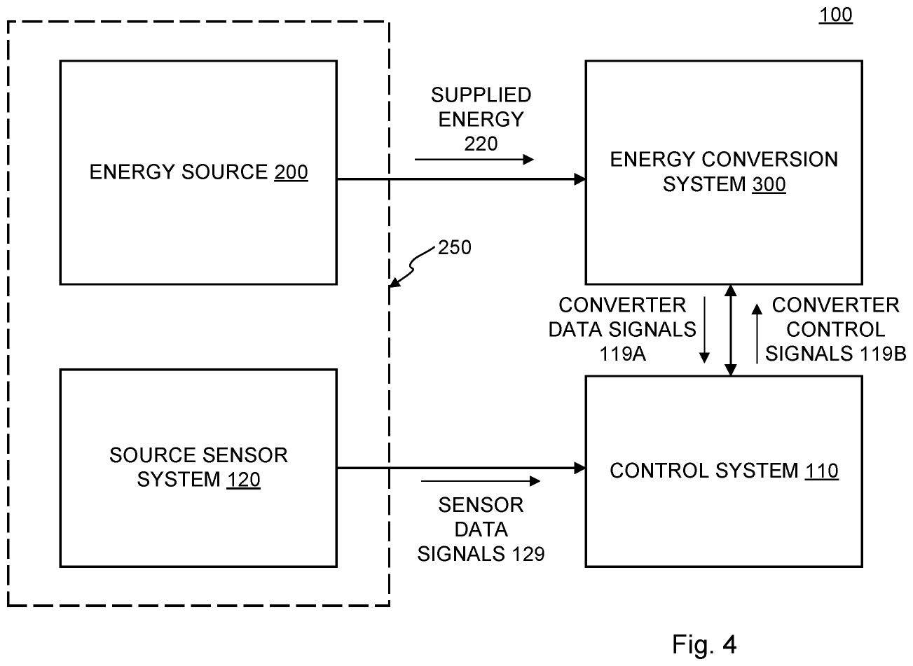

In the manner set forth above with reference to FIGS. 1A-B, the energy optimization system 100 can enable the energy source 200 to continuously operate at (or very near) peak power, preferably in real-time. Turning to FIG. 4, the energy optimization system 100 is shown as including a control circuit (or system) 110 for communicating with the energy conversion system 300. The control system 110 can establish and/or maintain an operating point (or region) of each energy source 200 for optimizing the supplied energy 220 provided by the energy source 200. In selected embodiments, the control system 110 can monitor the operating environment 250 associated with each energy source 200 and/or an operational status of each energy source 200.

The control system 110 can adjust the operating region of each energy source 200, adapting the operating region to any environmental change in the monitored operating environment 250 and/or any operational change to the monitored energy source 200. By establishing, maintaining and/or adjusting the operating region of each energy source 200, the control system 110 can control the supplied energy 220 available from each of the energy sources 200 and/or the output power 230 (shown in FIGS. 1A-B) generated by the energy optimization system 100. The control system 110 advantageously can extract the optimal or (very near) maximum level of supplied energy 220 available from each of the energy sources 200 by accounting for any environmental change in the monitored operating environment 250 and/or any operational change to the monitored energy source 200.

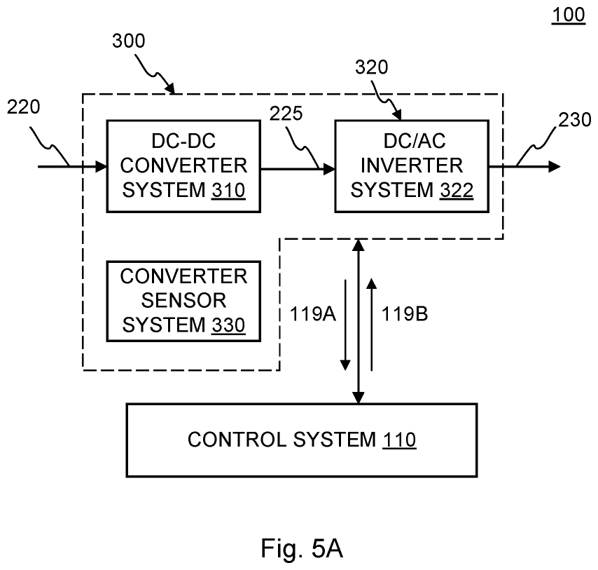

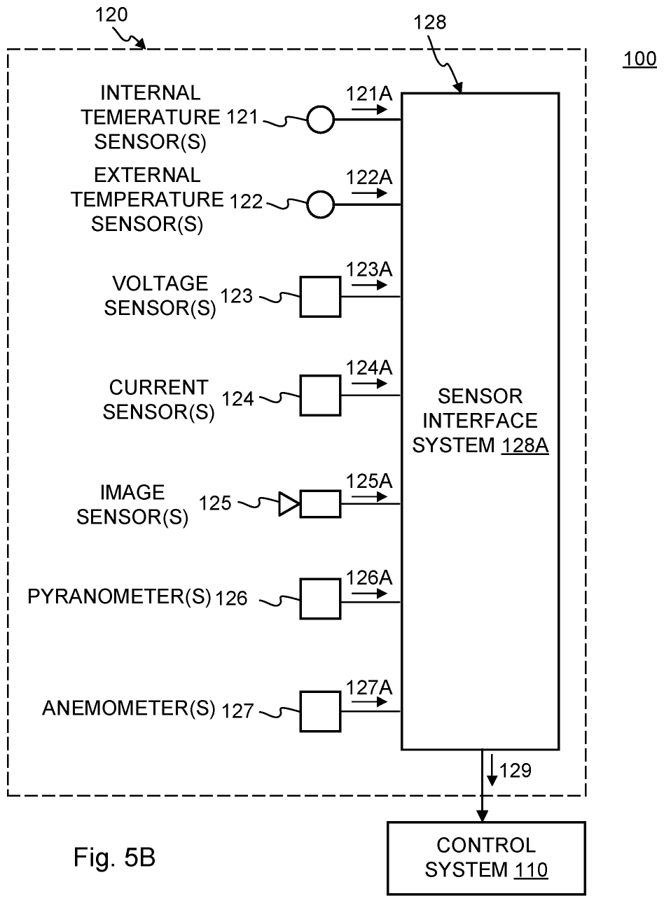

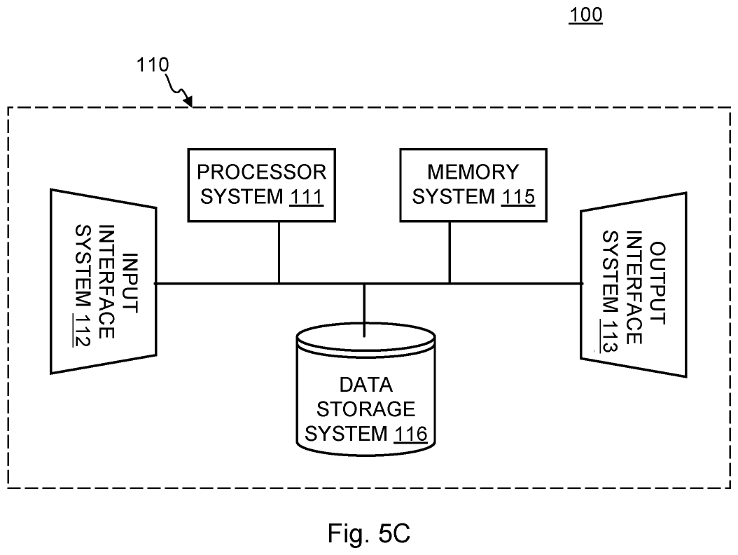

As illustrated in FIG. 4, the control system 110 can transmit one or more converter control signals 119B to the energy conversion system 300. The energy conversion system 300 can utilize the converter control signals 119B to establish and/or maintain the operating region of each energy source 200. An exemplary embodiment of the energy conversion system 300 is shown in FIG. 5A. Turning to FIG. 5A, the energy conversion system 300 can include the power inverter 320 in the manner set forth above with reference to FIG. 1B. The energy conversion system 300 of FIG. 5A is shown as comprising a direct current-to-direct current (or DC-to-DC) conversion circuit (or system) 310 in communication with a direct current-to-alternating current (or DC-to-AC) inverter circuit (or system) 322. The power inverter 320, for example, can include, but is not limited to, the DC-to-AC inverter system 322.

The DC-to-DC conversion system 310 can receive the electrical energy 220, such as the voltage, current and/or power, supplied by a relevant energy source 200 (shown in FIGS. 1A-B) and convert the received electrical energy 220 into an intermediate direct current (or DC) power 225, such as an intermediate DC voltage and/or an intermediate DC current. Exemplary DC-to-DC conversion systems 310 can include, but are not limited to, a boost converter circuit (or system), a buck converter circuit (or system) and/or a flyback converter circuit (or system). In selected embodiments, the boost converter system can comprise a conventional boost converter with one or more transistors, such as metal-oxide-semiconductor field-effect transistors (or MOSFETs) and/or insulated-gate bipolar transistors (or IGBTs), and/or one or more inductors, without limitation. The buck converter system, additionally and/or alternatively, can include, but is not limited to, a conventional buck converter with one or more transistors and/or one or more inductors.

One or more gate electrodes (not shown) of the metal-oxide-semiconductor field-effect transistors and/or insulated-gate bipolar transistors can receive one or more control signals, such as converter control signals 119B transmitted by the control system 110, for controlling the intermediate DC power 225. Advantageously, the converter control signals 119B can control the electrical energy 220 supplied by the relevant energy source 200 and/or the operating region of the relevant energy source 200. The intermediate DC power 225, the supplied electrical energy 220 and the operating region of the relevant energy source 200, for example, can be controlled by altering a duty cycle, a pulse width and/or a pulse duration of the converter control signals 119B provided to the gate electrodes within the DC-to-DC conversion system 310. The energy conversion system 300, in some embodiments, can comprise a pulse width modulation circuit (or system) and/or a pulse duration modulation circuit (or system) for controlling the electrical energy 220 supplied by the relevant energy source 200 and/or the operating region of the relevant energy source 200.

As illustrated in FIG. 5A, the DC-to-DC conversion system 310 can provide the intermediate DC power 225 to the DC-to-AC inverter system 322. The DC-to-DC conversion system 310, in other words, can include an output electrode (or terminal) for providing the intermediate DC power 225 and for coupling with an input electrode (or terminal) of the DC-to-AC inverter system 322. The DC-to-AC inverter system 322 can comprise one or more switches (not shown), such as one or more MOSFETs and/or one or more IGBTs, for transforming the intermediate DC power 225 into alternating current (or AC) output power 230.

The switches of the DC-to-AC inverter system 322 can receive one or more control signals, such as converter control signals 119B transmitted by the control system 110, for controlling the DC-to-AC inverter system 322 and/or the output power 230. In selected embodiments, the switches can inject a sequence of pulses into one or more inductors (not shown) and/or a transformer (not shown) for enabling the DC-to-AC inverter system 322 to form the AC output power 230 with a sinusoidal waveform from the intermediate DC power 225. In the manner discussed above with reference to FIG. 1B, the DC-to-AC inverter system 322 can provide the output power 230 with a form that is suitable for use by the load 400 (shown in FIG. 1B).

Returning to FIG. 4, the control system 110 is shown as being configured to monitor the operating environment 250 associated with each energy source 200 and/or an operational status of each energy source 200 via at least one sensor circuit (or system) 120. In other words, one or more sensor systems 120 can be disposed within the operating environment(s) 250 associated with the energy sources 200. For example, a first source sensor system 120 can be disposed within a first operating environment 250 associated with a first energy source 200, a second source sensor system 120 can be disposed within a second operating environment 250 associated with second and third energy sources 200 and/or third and fourth sensor systems 120 can be disposed within a third operating environment 250 associated with a fourth energy source 200. In selected embodiments, the source sensor system 120 can be disposed adjacent to a relevant energy source 200 and/or can be coupled or otherwise in communication with the relevant energy source 200.

The source sensor system 120 can be configured to measure at least one characteristic of the operating environment(s) 250 associated with the energy sources 200 and/or the operational status of the energy sources 200 and can provide one or more sensor data signals 129 for conveying information about the measured characteristic to the control system 110. As illustrated in FIG. 5B, for example, the source sensor system 120 for a preselected operating environment 250 and/or a preselected energy source 200 can include a predetermined number of sensor circuits (or subsystems) 121-127 for respectively measuring characteristics of the selected operating environment 250 and/or the operational status of the selected energy source 200. The sensor subsystems 121-127 can comprise any conventional type of sensor subsystem suitable for measuring any preselected characteristic of the operating environment(s) 250 and/or any preselected type of operational status of the energy sources 200.

Exemplary sensor subsystems can include, but are not limited to, one or more internal temperature sensor circuits (or subsystems) 121 for measuring a temperature inside the selected energy source 200 and/or one or more external temperature sensor circuits (or subsystems) 122 for measuring a temperature of the selected operating environment 250 outside of the selected energy source 200. The internal temperature sensor subsystem 121 can generate an internal temperature data signal 121A based upon the measured inside temperature and provide the internal temperature data signal 121A to the control system 110. In selected embodiments, the external temperature sensor subsystem 122 can generate an external temperature data signal 122A based upon the measured outside temperature and provide the external temperature data signal 122A to the control system 110.

Exemplary internal temperature sensor subsystems 121 and/or exemplary external temperature sensor subsystems 122 can comprise one or more thermocouples (not shown), one or more diodes (not shown), one or more resistors (not shown) and/or one or more other electrical (or electronic) temperature-sensing devices (not shown) that generate a voltage level, an impedance level or other value relative to temperature, without limitation. In selected embodiments, at least one of the internal temperature sensor subsystems 121 and/or external temperature sensor subsystems 122 can include a camera system (not shown) that is configured to capture one or more images of the thermal temperature at the selected energy source 200.

Additionally and/or alternatively, the sensor subsystems can include one or more voltage sensor circuits (or subsystems) 123 for measuring an output voltage generated by the selected energy source 200, one or more current sensor circuits (or subsystems) 124 for measuring an output current generated by the selected energy source 200 and/or one or more power sensor circuits (or subsystems) (not shown) for measuring an output power generated by the selected energy source 200, without limitation. The voltage sensor subsystem 123 can generate an output voltage measurement data signal 123A based upon the measured output voltage generated by the selected energy source 200 and provide the output voltage measurement data signal 123A to the control system 110. In selected embodiments, the current sensor subsystem 124 can generate an output current measurement data signal 124A based upon the measured output current generated by the selected energy source 200 and provide the output current measurement data signal 124A to the control system 110; whereas, the power sensor subsystem can generate an output power measurement data signal (not shown) based upon the measured output power generated by the selected energy source 200 and provide the output power measurement data signal to the control system 110.

The sensor subsystems optionally can include one or more image sensor circuits (or subsystems) 125 for capturing at least one image of the selected operating environment 250 and/or the selected energy source 200, one or more pyranometer sensor circuits (or subsystems) 126 for measuring (solar) irradiance at the selected operating environment 250 and/or the selected energy source 200 and/or one or more anemometer sensor circuits (or subsystems) 127 for measuring wind speed at the selected operating environment 250 and/or the selected energy source 200 can be included among the sensor subsystems. The image sensor subsystem 125 can generate an image data signal 125A based upon the captured images and provide the image data signal 125A to the control system 110.

In selected embodiments, the image sensor subsystem 125 can comprise a temperature-activated imaging sensor subsystem that can be respond to the temperature inside the selected energy source 200 and/or the temperature of the selected operating environment 250. The image sensor subsystem 125, for example, can be activated for capturing the image of the selected operating environment 250 and/or the selected energy source 200 when the temperature inside the selected energy source 200 is greater than or equal to a predetermined energy source threshold temperature and/or when the temperature within the selected operating environment 250 is greater than or equal to a predetermined operating environment threshold temperature. In other words, the image sensor subsystem 125 can be activated for capturing the image of the selected operating environment 250 and/or the selected energy source 200 when the internal temperature of the selected energy source 200 as measured by the internal temperature sensor subsystem 121 is greater than or equal to the predetermined energy source threshold temperature and/or when the temperature of the selected operating environment 250 outside of the selected energy source 200 as measured by the external temperature sensor subsystems 122 is greater than or equal to the predetermined operating environment threshold temperature.

Additionally and/or alternatively, the pyranometer sensor subsystem 126 can generate an irradiance data signal 126A based upon the measured irradiance and provide the irradiance data signal 126A to the control system 110, and/or the anemometer sensor subsystem 127 can generate a wind speed data signal 127A based upon the measured wind speed and provide the wind speed data signal 127A to the control system 110. Although shown and described with reference to FIG. 5B as comprising selected exemplary sensor subsystems 121-127 for purposes of illustration, the source sensor system 120 can include any combination, arrangement or collection of sensor subsystems for measuring selected characteristics of the operating environment(s) 250 associated with the energy sources 200 and/or the operational status of the energy sources 200 and providing sensor signals 121A-127A for conveying information about the measured characteristics to the control system 110.

The source sensor system 120 advantageously can detect a current environmental status (and/or any environmental change) within the operating environment 250 of the energy source 200 and/or a current operational status of (and/or any operational change to) the energy source 200 itself. With reference to FIG. 5B, the internal temperature sensor subsystem 121 and/or the external temperature sensor subsystem 122, for example, can measure a current temperature status and/or any temperature change at the operating environment 250. The pyranometer sensor subsystem 126 can measure a current irradiance or a change in the irradiance at the operating environment 250; whereas, the anemometer sensor subsystem 127 can measure a wind speed or a change in the wind speed at the operating environment 250, without limitation.

Other optional environmental factors, such as a current water (or tide) level and/or any water (or tide) level change, can be measured via one or more appropriate sensor subsystems of the source sensor system 120 based, for example, upon the nature of the energy source(s) 200.

The selection of sensor subsystems, for example, can be based in part upon a nature of a particular energy source 200. In other words, one or more sensor subsystems can be selected based upon a manner, such as through solar, wind, tidal and thermal generation, by which a particular energy source 200 supplies the supplied energy 220.

If the energy source 200 comprises a wind energy source, for example, the sensor subsystems can include, are not limited to, one or more anemometer sensor subsystems 127 as discussed above, one or more torque sensor circuits (or subsystems) (not shown) for measuring a torque generated by the wind energy source and/or one or more angular speed sensor circuits (or subsystems) (not shown) for measuring an angular speed of the wind energy source. Additionally and/or alternatively, the sensor subsystems can include one or more accelerometers or other water level sensor circuits (or subsystems) (not shown) for measuring a current water level and/or any rate of change in the water level, without limitation, if the energy source 200 includes a tidal energy source.

Environmental changes within the operating environment 250 can be associated with changes in temperature, solar position and/or weather. Additionally and/or alternatively, the current operational status and/or any operational change to the energy source 200 due to aging, (incremental) soiling, sun soaking, and/or cleaning or other maintenance of the energy source(s) 200 can be detected via the source sensor system 120. Exemplary sensor subsystems for detecting the current operational status and/or any operational change to the energy source 200 can include, but are not limited to, the voltage sensor subsystem 123, current sensor subsystem 124 and/or image sensor subsystem 125.

The sensor subsystems 121-127 can provide the sensor signals 121A-127A to the control system 110 in any conventional manner. The sensor subsystems 121-127 and the control system 110, for example, can be coupled via a wireless communication system (not shown) and/or a wired communication system 128 as illustrated in FIG. 5B. The sensor subsystems 121-127, additionally and/or alternatively, can communicate with the control system 110 directly and/or indirectly. In other words, the sensor subsystems 121-127 can be directly coupled with the control system 110 and/or indirectly coupled with the control system 110 via one or more intermediate system elements.

As shown in FIG. 5B, for example, the sensor subsystems 121-127 can be coupled with the control system 110 via a sensor interface circuit (or system) 128A. The sensor interface system 128A is shown as receiving the sensor signals 121A-127A from the respective sensor subsystems 121-127 and providing the sensor signals 121A-127A as the sensor data signals 129 to the control system 110. In other words, the sensor interface system 128A can combine the sensor signals 121A-127A to provide the sensor data signals 129 as a composite of the sensor signals 121A-127A. The sensor interface system 128A can combine the sensor signals 121A-127A in any suitable manner, such as time-division multiplexing, frequency-division multiplexing and/or superpositioning, without limitation.

Returning briefly to FIG. 5A, a converter sensor circuit (or system) 330 can be associated with the energy conversion system 300. The converter sensor system 330, in selected embodiments, can measure the current, voltage and/or power of the electrical energy 220 received at the energy conversion system 300, the intermediate DC power 225 and/or the output power 230 generated by the energy conversion system 300. The converter sensor system 330 can provide the current, voltage and/or power measurements to the control system 110 via one or more converter data signals 119A.

In selected embodiments, the converter sensor system 330 can include one or more voltage sensor circuits (or subsystems) for providing the voltage measurements to the control system 110, one or more current sensor circuits (or subsystems) (not shown) for providing the current measurements to the control system 110 and/or one or more power sensor circuits (or subsystems) for providing the power measurements to the control system 110. The voltage sensor subsystem, for example, can be provided in the manner by which the voltage sensor subsystem 123 is provided with reference to FIG. 5B. Additionally and/or alternative, the current sensor subsystem can be provided in the manner by which the current sensor subsystem 124 is provided with reference to FIG. 5B.

In selected embodiments, a selected voltage sensor subsystem of the converter sensor system 330 can be coupled with an input terminal of the DC-to-DC conversion system 310 to measure a voltage level of the supplied electrical energy 220 as received at the DC-to-DC conversion system 310. The selected voltage sensor subsystem can comprise an analog-to-digital converter (or ADC) voltage sensor subsystem for providing a selected converter data signal 119A with a digital word corresponding to the measured voltage level. Optionally, a selected current (or power) sensor subsystem of the converter sensor system 330 can be coupled with the input terminal of the DC-to-DC conversion system 310 to measure a current (or power) level of the supplied electrical energy 220 as received at the DC-to-DC conversion system 310. The selected power sensor subsystem can comprise a shunt resistor, a differential operational amplifier sensor subsystem and/or a Hall Effect sensor subsystem for providing a selected converter data signal 119A with a signal voltage level corresponding to the measured power level.

Additionally and/or alternatively, the converter sensor system 330, for example, can include one or more current (or power) sensor circuits (or subsystems) (not shown) that can be coupled with an output terminal of the DC-to-DC conversion system 310. The current (or power) sensor subsystems can be provided in the manner discussed with reference to the current sensor subsystems 124 and/or power sensor subsystems of FIG. 5B and/or can measure the current (or power) supplied by the DC-to-DC conversion system 310. In selected embodiments, the power sensor subsystem can comprise a shunt resistor, a differential operational amplifier sensor subsystem and/or a Hall Effect sensor subsystem for providing a selected converter data signal 119A with a signal voltage level corresponding to the measured power level. The current sensor subsystem can generate a current (or power) measurement data signal based upon the measured current (or power) supplied by the DC-to-DC conversion system 310 and include the output current (or power) measurement data signal among the converter data signals 119A provided by the energy conversion system 300 and/or the converter sensor system 330 to the control system 110.

The converter sensor system 330 optionally can include one or more voltage sensor circuits (or subsystems) (not shown) for measuring the intermediate direct current (or DC) voltage 225 supplied by the DC-to-DC conversion system 310. The voltage sensor subsystems can be provided in the manner discussed with reference to the voltage sensor subsystems 123 of FIG. 5B and/or can be coupled with the output terminal of the DC-to-DC conversion system 310. In selected embodiments, the voltage sensor subsystem can comprise an analog-to-digital converter (or ADC) voltage sensor subsystem for providing a selected converter data signal 119A with a digital word corresponding to the measured voltage level. The voltage sensor subsystem can generate a voltage measurement data signal based upon the measured voltage supplied by the DC-to-DC conversion system 310 and include the output voltage measurement data signal among the converter data signals 119A provided by the energy conversion system 300 and/or the converter sensor system 330 to the control system 110.

Additionally and/or alternatively, the converter sensor system 330 optionally can include one or more power sensor circuits (or subsystems) (not shown) for measuring the power supplied by the DC-to-DC conversion system 310. The power sensor subsystems can be provided in the manner discussed with reference to the power sensor subsystems of FIG. 5B and/or can be coupled with the output terminal of the DC-to-DC conversion system 310. The power sensor subsystem can generate a power measurement data signal based upon the measured power supplied by the DC-to-DC conversion system 310 and include the output power measurement data signal among the converter data signals 119A provided by the energy conversion system 300 and/or the converter sensor system 330 to the control system 110.

In selected embodiments, the converter sensor system 330 can be separate from, and/or at least partially integrated with, the energy conversion system 300. If integrated with the energy conversion system 300, the converter sensor system 330 can be disposed adjacent to the DC-to-DC conversion system 310 and/or the DC-to-AC inverter system 322. The converter sensor system 330 optionally can be coupled or otherwise in communication with the DC-to-DC conversion system 310 and/or the DC-to-AC inverter system 322. Although shown and described as measuring voltage, current and/or power with reference to FIG. 5A, the converter sensor system 330 can be configured to measure or otherwise monitor any characteristic(s) of the energy conversion system 300. The converter sensor system 330, for example, can be configured to measure or otherwise monitor a temperature, such as an internal temperature, of the energy conversion system 300. Stated somewhat differently, the converter sensor system 330 can monitor a health of the energy conversion system 300.

The control system 110 can receive the sensor data signals 129 from each source sensor system 120 and/or the converter data signals 119A from the energy conversion system 300. An exemplary control system 110 is illustrated in FIG. 5C. Turning to FIG. 5C, the exemplary control system 110 is shown as comprising a processor circuit (or system) 111 in communication with an input interface circuit (or system) 112 and/or an output interface circuit (or system) 113. In selected embodiments, the input interface system 112 and the output interface system 113 can be at least partially combined into an input/output (or I/O) interface system. The processor system 111 can comprise any appropriate number and type of conventional computer processing systems, such as one or more microprocessors (μPs), central processing units (CPUs), digital signal processors (DSPs), and/or coder/decoders (CODECs), without limitation.

Additionally and/or alternatively, the control system 110 can be implemented via a microcontroller (not shown). The microcontroller can include a processor, a random access memory, a non-volatile erasable memory, and/or general purpose registers that can be configured as an input/output interface system. Some microcontrollers, for example, can have an ethernet interface capable of receiving and/or sending network signals. Other related alternate embodiments of the control system 110 can include a plurality of microcontrollers being configured to distribute a workload of the control system 110 among the microcontrollers.

The control system 110 of FIG. 5C is shown as being configured to communicate with the input interface system 112 and/or the output interface system 113 via an internal communication bus 114. Via the internal communication bus 114, the processor system 111 can exchange data signals, address signals and/or control signals (not shown) with the input interface system 112 and/or the output interface system 113. The control system 110 optionally can include a memory system 115 and/or a data storage system 116.

The memory system 115 and/or data storage system 116 can communicate with the processor system 111, the input interface system 112 and/or the output interface system 113 via the internal communication bus 114. The memory system 115 and/or data storage system 116 can comprise any conventional type of volatile and/or non-volatile memory system, such as any suitable electronic, magnetic, and/or optical storage media, without limitation. Exemplary storage media can include one or more static random access memories (SRAMs), dynamic random access memories (DRAMs), electrically-erasable programmable read-only memories (EEPROMs), FLASH memories, hard drives (HDDs), compact disks (CDs), and/or digital video disks (DVDs) of any kind.

In selected embodiments, the memory system 115 and/or data storage system 116 can store data and other information generated by the energy optimization system 100. Exemplary information can include, but is not limited to, conversion system information provided by the energy conversion system 300 (shown in FIG. 4) via the converter data signals 119A (shown in FIG. 4) and/or sensor system information provided by the source sensor system 120 (shown in FIG. 4) via the sensor data signals 129. Additionally and/or alternatively, the optional memory system 115 and/or data storage system 116 can comprise non-transitory machine-readable storage media upon which software code is stored for execution by the processor system 111. The software code, when executed by the processor system 111, can determine a process or other manner by which the control system 110 and/or the energy optimization system 100 operate.

Returning to FIGS. 4, 5A and 5B, the control system 110 can receive the sensor data signals 129, in whole and/or in part, from the source sensor system 120 via the input interface system 112. The control system 110, for example, can receive the sensor signals 121A-127A directly from the sensor subsystems 121-127 or indirectly from the sensor subsystems 121-127, such as via the sensor interface system 128A. Additionally and/or alternatively, the control system 110 can communicate with the energy conversion system 300 via the input interface system 112 and/or the output interface system 113.

The control system 110, for example, receive the converter data signals 119A from the energy conversion system 300 via the input interface system 112 and/or can transmit the converter control signals 119B to the energy conversion system 300 via the output interface system 113. The control system 110 can utilize the sensor data signals 129 received from the source sensor system 120 and/or the converter data signals 119A received from the energy conversion system 300 to generate the converter control signals 119B for transmission to the energy conversion system 300. Stated somewhat differently, the control system 110 can generate the converter control signals 119B based upon the conversion system information provided by the energy conversion system 300 via converter data signals 119A and/or the sensor system information provided by the source sensor system 120 via the sensor data signals 129.

In the manner discussed in more detail above with reference to FIG. 5A, the converter control signals 119B can include pulse width modulation signals and/or a pulse duration modulation signals for controlling operation of the DC-to-DC conversion system 310 and/or the DC-to-AC inverter system 322. The control system 110, in other words, can utilize the converter control signals 119B for controlling the pulse width modulation circuit (or system) and/or a pulse duration modulation circuit (or system) of the energy conversion system 300.

For example, the control system 110 can enable the energy conversion system 300 to establish and/or maintain the operating region of a relevant energy source 200 by setting and/or adjusting the electrical energy 220, such as the voltage, current and/or power, supplied by the relevant energy source 200. The energy conversion system 300, in other words, can establish and/or maintain the operating region of the relevant energy source 200 by setting and/or adjusting the electrical energy 220 via the converter control signals 119B provided by the control system 110. The electrical energy 220 thereby can be supplied by the relevant energy source 200 such that the supplied electrical energy 220 is at peak (or near-peak).

In other words, the energy conversion system 300 and the control system 110 can interact to establish and/or maintain the operating region of the relevant energy source 200. The control system 110, in selected embodiments, can utilize a quantitative method (or model) for computing or otherwise determining the optimal (or near-optimal) operating region of the relevant energy source 200. The control system 110 and the energy conversion system 300, for example, can exchange data and other information. Exemplary information provided by the energy conversion system 300 can include, but is not limited to, conversion system information via the converter data signals 119A. The converter data signals 119A can include current, voltage and/or power measurements of the electrical energy 220 received at the energy conversion system 300, the intermediate DC power 225 (shown in FIG. 5A) and/or the output power 230 generated by the energy conversion system 300, without limitation.

The control system 110 and the source sensor system 120, additionally and/or alternatively, can exchange sensor system information provided by the source sensor system 120 via the sensor data signals 129. Exemplary sensor system information can include, but is not limited to, the measurements and other data generated by the sensor subsystems 121-127 (shown in FIG. 5B) and included in the sensor signals 121A-127A (shown in FIG. 5B). The control system 110 can process the conversion system information and/or the sensor system information.

If the relevant energy source 200 comprises a photovoltaic device 210 (shown in FIG. 1B) and is subjected to an irradiance that decreases from 1000 watts per meter to 200 watts per square meter, the control system 110 can transmit one or more converter control signals 119B to the energy conversion system 300. The energy conversion system 300 thereby can adjust the operating region of the photovoltaic device 210 from the inflection region 1532C (shown in FIG. 3A) of the third power-voltage characteristic curve 1530C (shown in FIG. 3A) that corresponds to an irradiance of 1000 watts per square meter to the inflection region 1532A (shown in FIG. 3A) of the first power-voltage characteristic curve 1530A (shown in FIG. 3A) that corresponds to an irradiance of 200 watts per square meter.

The control system 110, for example, can alter the duty cycle, the pulse width and/or the pulse duration of the converter control signals 119B provided to the energy conversion system 300 in the manner discussed in more detail above with reference to FIG. 5A. Stated somewhat differently, control system 110 can adjust the duty cycle of the DC-to-DC conversion system 310 (shown in FIG. 5A) and/or the DC-to-AC inverter system 322 (shown in FIG. 5A) in real time. The energy conversion system 300 thereby can control the electrical energy 220 supplied by the relevant energy source 200, the operating region of the relevant energy source 200 and/or the intermediate DC power 225 (shown in FIG. 5A), and the DC-to-AC inverter system 322 can transform the intermediate DC power 225 into the alternating current (or AC) output power 230. The relevant energy source 200 advantageously can continuously operate at (or very near) peak power despite changes in the operating environment 250 associated with the relevant energy source 200 and/or an operational status of the relevant energy source 200 itself.

The control system 110 optionally can communicate with one or more other system elements of the energy optimization system 100. For example, the input interface system 112 and/or the output interface system 113 of the control system 110 can exchange one or more sensor data signals 129 (shown in FIG. 4) and/or one or more optional sensor control signals with the source sensor system 120. Stated somewhat differently, the control system 110 can receive the sensor data signals 129 from the source sensor system 120 and/or transmit the sensor control signals to the source sensor system 120.

Accordingly, the control system 110 can enable near-instantaneous (or real-time) establishing, maintaining and/or adjusting of the operating region of the energy source(s) 200 associated with the energy optimization system 100. The control system 110 advantageously can establish, maintain and/or adjust the operating region of the energy source(s) 200 regardless of any environmental change in the monitored operating environment 250 and/or any operational change to the monitored energy source 200. In selected embodiments, the control system 110 can account for rapid environmental changes and/or operational changes when establishing, maintaining and/or adjusting the operating region of the energy source(s) 200. The energy optimization system 100 thereby can enable the energy source(s) 200 to continuously operate at (or very near) peak power.

In the manner set forth above with reference to FIGS. 4, 5A and 5B, the energy optimization system 100, in selected embodiments, can utilize a quantitative method for computing or otherwise determining optimal (or near-optimal) operating region(s) for the energy source(s) 200 in real time. The quantitative method, in other words, can enable the energy source(s) 200 to continuously operate at (or very near) peak power. For example, the control system 110 can combine the conversion system information provided by the energy conversion system 300 via the converter data signals 119A and/or the sensor system information provided by the source sensor system 120 via the sensor data signals 129 in a quantitative model to compute the operating region(s) for the energy source(s) 200.

The quantitative model, for example, can comprise a quantitative model for each of the energy sources 200. Using the quantitative model for a selected energy source 200, the energy optimization system 100 can determine an optimal (or near-optimal) operating region for the selected energy source 200 and, as needed, establish, maintain and/or adjust the pulse width modulation signals and/or a pulse duration modulation signals of the converter control signals 119B provided to the energy conversion system 300 for maximizing or otherwise optimizing the output power 230 that is generated by the energy conversion system 300.

If the selected energy source 200 comprises a photovoltaic device 210 (shown in FIG. 1B), for example, one embodiment of the quantitative model can include an equation that relates the output voltage and/or the output current supplied by the photovoltaic device 210 with a set of predetermined quantitative model parameters. Equation 1 below comprises an exemplary quantitative model equation for a representative photovoltaic device 210.

I_{OUT}=I_{LIGHT}−Iₒ*(exp(V_{OUT}/((n*K*T)/q))) (Equation 1)

wherein I_{OUT} is the output current supplied by the photovoltaic device 210, I_{LIGHT} is a current generated from incident light, Iₒ is a reverse saturation current, V_{OUT} is the output voltage supplied by the photovoltaic device 210, n is a diode ideality factor, K is the Boltzmann constant, T is a temperature of the photovoltaic device 210 in Kelvin, and q is the elementary charge of an electron.

The power from the electrical energy 220 supplied by the photovoltaic device 210 can be defined as a product of the output current I_{OUT} supplied by the photovoltaic device 210 and the output voltage V_{OUT} supplied by the photovoltaic device 210. Since the reverse saturation current Iₒ, the diode ideality factor n, the Boltzmann constant K, the temperature T in Kelvin, and the elementary charge q can be given and the output current I_{OUT} and the output voltage V_{OUT} supplied by the photovoltaic device 210 can be measured, Equation 1 can be rewritten as Equation 2 for determining the current I_{LIGHT} generated from incident light.

I_{LIGHT}=I_{OUT}+Iₒ*(exp(V_{OUT}/((n*K*T)/q))) (Equation 2)

Upon determining the current I_{LIGHT} generated from incident light from Equation 2, the control system 110 can vary the output voltage V_{OUT} supplied by the photovoltaic device 210 for maximizing or otherwise optimizing the power supplied by the photovoltaic device 210, which power is the product of the output current I_{OUT} and the output voltage V_{OUT} supplied by the photovoltaic device 210 in the manner set forth above.

In selected embodiments, selected characteristics, such as the reverse saturation current Iₒ and/or the diode ideality factor n, of the photovoltaic device 210 may be approximated and/or can vary, for example, as the photovoltaic device 210 ages. An expected output current I_{OUT_ANTICIPATED} to be supplied by the photovoltaic device 210 therefore may differ from an actual output current I_{OUT_ACTUAL} that is supplied by the photovoltaic device 210. Although typically small, a difference between the expected output current I_{OUT_ANTICIPATED} of the photovoltaic device 210 and the actual output current I_{OUT_ACTUAL} of the photovoltaic device 210 can adversely impact the power supplied by the photovoltaic device 210 via the control system 110. The photovoltaic device 210 thus may operate at (very) near peak power.

To further improve the actual output current I_{OUT_ACTUAL} of the photovoltaic device 210, the energy optimization system 100 can utilize the quantitative methods to compute more accurate values for the selected characteristics of the photovoltaic device 210. The quantitative methods, for example, can be utilized to compute more accurate values for the reverse saturation current Iₒ and/or the diode ideality factor n of the photovoltaic device 210. In one embodiment, data related to the actual output current I_{OUT_ACTUAL} of the photovoltaic device 210, the expected output current I_{OUT_ANTICIPATED} of the photovoltaic device 210, the output voltage V_{OUT} supplied by the photovoltaic device 210, the temperature T, the reverse saturation current Iₒ, and/or the diode ideality factor n of the photovoltaic device 210 can be collected throughout a predetermined period of time.

The energy optimization system 100 can utilize the quantitate methods, such as gradient descent, to determine an updated value for the reverse saturation current Iₒ and/or an updated value for the diode ideality factor n of the photovoltaic device 210 based upon the collected data. By using the updated value for the reverse saturation current Iₒ and/or the updated value for the diode ideality factor n of the photovoltaic device 210, the energy optimization system 100 can determine an updated optimal (or near-optimal) operating region for the photovoltaic device 210 and enable the photovoltaic device 210 to operate at an improved peak power.

Although discussed above with reference to a selected quantitative model for purposes of illustration only, the energy optimization system 100 can utilize one or more other embodiments of the quantitative model for photovoltaic device 210. The other embodiments of the quantitative model can include more complicated solar cell/array/string models, models that attempt to interpolate between measured data points, or any other quantitative model, without limitation. Additionally and/or alternatively, the energy optimization system 100 can include any number and/or type of energy sources 200, including a wind energy source, a tidal energy source and/or a thermal energy source in the manner discussed above with reference to FIG. 1A and can utilize one or more quantitative models for predicting an operational behavior of each energy source 200.

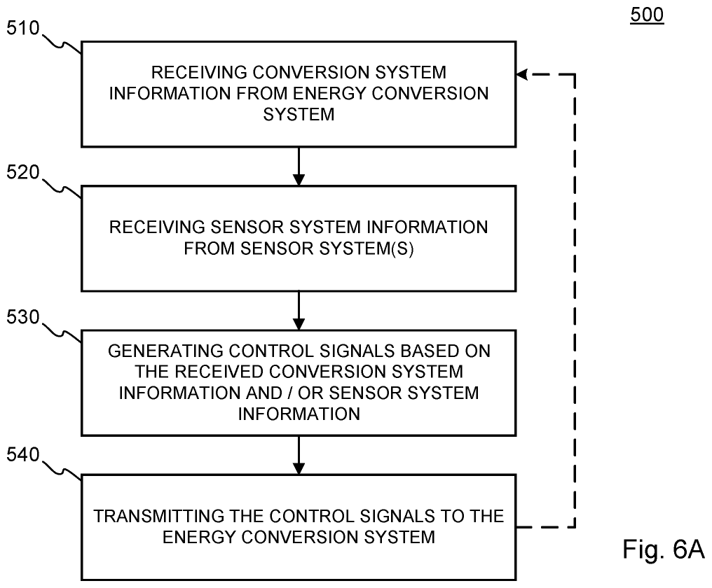

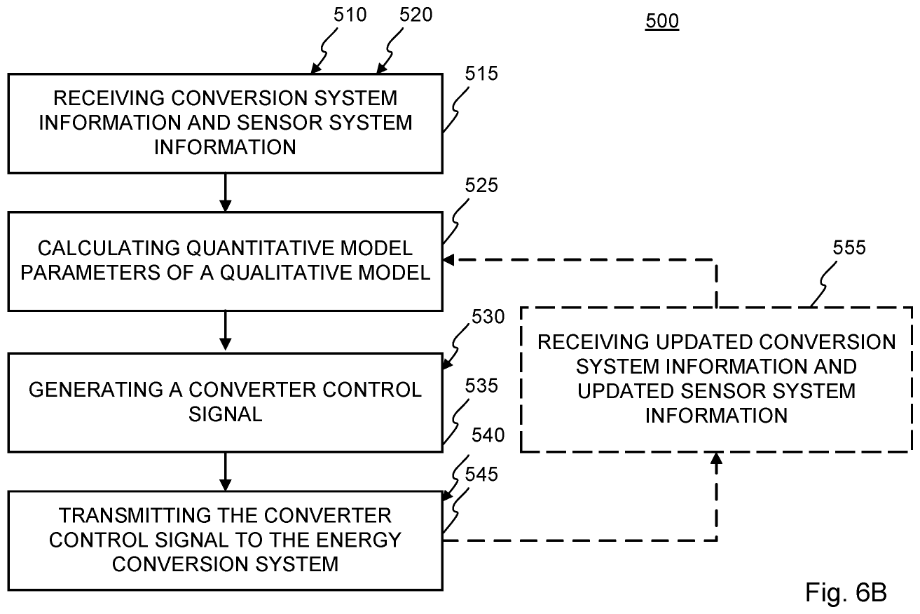

An exemplary embodiment of an energy optimization method 500 for the energy optimization system 100 is illustrated in FIG. 6A. The energy optimization method 500, for example, can be performed via the control system 110. Turning to FIG. 6A, the energy optimization method 500 can include receiving, at 510, conversion system information provided by the energy conversion system 300. The conversion system information, for example, can be received from the energy conversion system 300 via the converter data signals 119A in the manner discussed in more detail above with reference to FIGS. 4 and 5A-C. At 520, sensor system information provided by the source sensor system(s) 120 can be received. In selected embodiments, the sensor system information can be provided by the source sensor system 120 via the sensor data signals 129 in the manner discussed in more detail above with reference to FIGS. 4 and 5A-C.

The energy optimization method 500, at 530, can include generating one or more control signals based upon the received conversion system information and/or the received sensor system information. The control signals can comprise the converter control signals 119B for controlling operation of the energy conversion system 300 in the manner discussed in more detail above with reference to FIGS. 4 and 5A-C. At 540, the control signals can be transmitted to the energy conversion system 300 and/or the source sensor system 120.

The energy optimization method 500 optionally can repeat if new or otherwise updated conversion system information becomes available from the energy conversion system 300 and/or if new or otherwise updated sensor system information becomes available from the source sensor system(s) 120. In other words, the updated conversion system information can be received from the energy conversion system 300, at 510, and/or the updated sensor system information can be received from the source sensor system(s) 120, at 520. The energy optimization method 500, at 530, can include generating one or more control signals based upon the updated conversion system information and/or the updated sensor system information. At 540, the control signals can be transmitted to the energy conversion system 300 and/or the source sensor system 120.

The energy optimization method 500 advantageously can continuously receive conversion system information, at 510, and/or can continuously receive sensor system information, at 520. The converter control signals 119B for controlling operation of the energy conversion system 300 likewise can be continuously generated, at 530, and transmitted to the energy conversion system 300, at 540, preferably in real time. In the manner discussed in more detail above with reference to FIGS. 4 and 5A-C, for example, the energy conversion system 300 can utilize the converter control signals 119B to establish, maintain and/or adjust the operating region of each energy source 200.

FIG. 6B shows an exemplary alternative energy optimization method 500. The energy optimization method 500 can be utilized to optimize a peak power of an energy source 200 that is disposed within the operating environment 250 and that is supplying the electrical energy 220 to the energy conversion system 300 for generating the output power 230 based upon the supplied electrical energy 220 in the manner shown and described above with reference to FIGS. 1A-B. As illustrated in FIG. 6B, the energy optimization method 500 can include, at 515, receiving conversion system information from the energy conversion system 300 and sensor system information from one or more sensor systems 120 within the operating environment 250. The conversion system information, for example, can be received from the energy conversion system 300 via the converter data signals 119A and/or the sensor system information can be received from the source sensor system 120 via the sensor data signals 129 in the manner discussed in more detail above with reference to FIGS. 4 and 5A-C.

One or more quantitative model parameters of a quantitative model for predicting an operational behavior of the energy source can be calculated, at 525, based upon the received conversion system information and the received sensor system information. The quantitative model parameters optionally can be continuously recalculated to account for any environmental changes in the operating environment 250 and/or any operational changes to the energy source 200 itself. In selected embodiments, the quantitative model parameters can be calculated in the manner discussed above with regard to FIGS. 4 and 5A-C. The quantitative model parameters, for example, can be calculated in accordance with Equations 1 and 2 above.

At 535, a converter control signal for establishing an optimal operating region of the energy source can be generated based upon the calculated quantitative model parameters. The control signals can comprise the converter control signals 119B for controlling operation of the energy conversion system 300 in the manner discussed in more detail above with reference to FIGS. 4 and 5A-C. Using the quantitative model for the energy source 200, the energy optimization method 500 can determine an optimal (or near-optimal) operating region for the energy source 200 and, as in selected embodiments, can establish, maintain and/or adjust the pulse width modulation signals and/or a pulse duration modulation signals of the converter control signals 119B.

The converter control signal can be transmitted, at 545, to the energy conversion system 300 and/or the source sensor system 120. The energy conversion system 300 thereby can set the supplied energy 220 from the energy source 200 based upon the converter control signal to establish a first operating region for enabling the energy source 200 to operate at a peak power.

The energy optimization method 500 optionally can repeat if new or otherwise updated conversion system information becomes available from the energy conversion system 300 and/or if new or otherwise updated sensor system information becomes available from the source sensor system(s) 120. Stated somewhat differently, the updated conversion system information can be received from the energy conversion system 300 and/or the updated sensor system information can be received from the source sensor system(s) 120, at 555. The energy optimization method 500, at 525, can include calculating updated quantitative model parameters of the quantitative model based upon the updated conversion system information and/or the updated sensor system information, and, at 535, generating an updated converter control signal for establishing an updated optimal operating region of the energy source based upon the updated quantitative model parameters. The updated converter control signal can be transmitted, at 545, to the energy conversion system 300 and/or the source sensor system 120. The energy conversion system 300 thereby can adjust the supplied energy 220 from the energy source 200 based upon the updated converter control signal to establish a second operating region for enabling the energy source 200 to continue to operate at the peak power.

In selected embodiments, the energy optimization method 500 can continuously receive conversion system information and/or sensor system information. The energy optimization method 500 advantageously can continuously calculate updated quantitative model parameters of the quantitative model based upon the received conversion system information and/or sensor system information, at 525, and continuously generate an updated converter control signal, at 535, based upon the quantitative model parameters for transmission to the energy conversion system 300 and/or the source sensor system 120, at 545, preferably in real time. In the manner discussed in more detail above with reference to FIGS. 4 and 5A-C, for example, the energy conversion system 300 can utilize the converter control signals 119B to establish, maintain and/or adjust the operating region of each energy source 200.

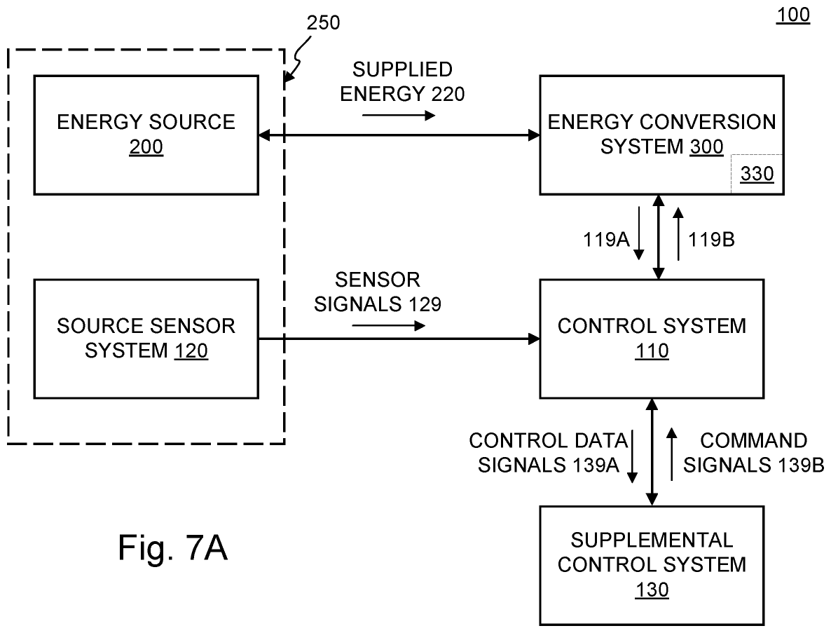

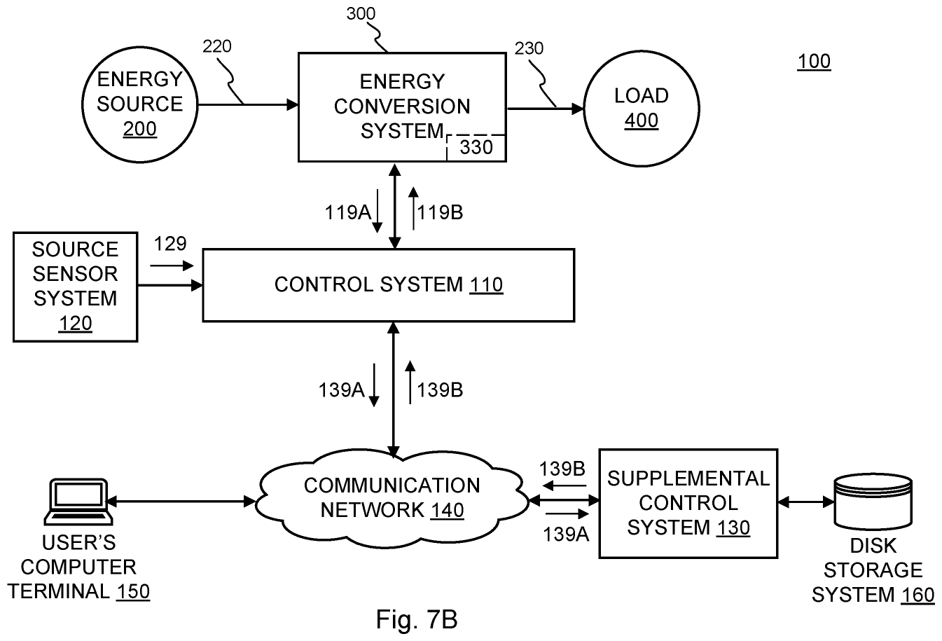

The energy optimization system 100 of FIG. 7A is illustrated as including an optional supplemental control system 130 for monitoring, commanding, and/or controlling the energy optimization system 100. Turning to FIG. 7A, the supplemental control system 130 can be configured to communicate with the control system 110 in any conventional manner. The control system 110, for example, can communicate with the supplemental control system 130 via the input interface system 112 (shown in FIG. 5C) and/or the output interface system 113 (shown in FIG. 5C) of the control system 110. The supplemental control system 130 and the control system 110 thereby can exchange system data, system status and/or system command signals, preferably in accordance with a packetized communication protocol and/or in a periodic manner or an aperiodic manner.

As shown in FIG. 7A, the control system 110 can transmit one or more control data signals 139A to the supplemental control system 130; whereas, the supplemental control system 130 can transmit one or more command signals 139B to the control system 110. The supplemental control system 130 can be distal from, and/or proximal to, the control system 110. Stated somewhat differently, the supplemental control system 130 can be at least partially integrated with, or external from, the control system 110. An energy management processing circuit (or system) can include the control system 110 and/or the supplemental control system 130.

A system operator or other user (not shown), in selected embodiments, can interact or otherwise communicate with the energy optimization system 100. In selected embodiments, the user can communicate with the energy optimization system 100 directly and/or can utilize an optional user computer system 150 (shown in FIG. 7B) or similar device to communicate with the energy optimization system 100 via the control system 110 and/or the supplemental control system 130. The control system 110 and/or the supplemental control system 130, for example, can exchange data, status and/or command signals with the user computer system 150, preferably in accordance with a packetized communication protocol. Through the supplemental control system 130, the system user can initiate one or more system functions, such as, checking a status of the energy optimization system 100, reviewing information about energy production by the energy optimization system 100 and/or assessing a health of the energy optimization system 100, without limitation.

Additionally and/or alternatively, the supplemental control system 130 can aggregate historical system data for the energy optimization system 100. The historical system data for the energy optimization system 100, in selected embodiments, can be available from the control system 110. The historical system data can include, but is not limited to, historical conversion system information previously provided by the energy conversion system 300 and/or historical sensor system information previously provided by the source sensor system 120. For instance, the historical system data can comprise historical voltage, current and/or power measurement data. Exemplary historical voltage measurement data can include historic voltage measurement data from the voltage sensor subsystem 123 (shown in FIG. 5B) and/or the converter sensor system 330 (shown in FIG. 5A), without limitation.

The historical current measurement data can include historic current measurement data from the current sensor subsystem 124 (shown in FIG. 5B) and/or the converter sensor system 330, and/or the historical power measurement data can include historic power measurement data from the power sensor subsystem (not shown) and/or the converter sensor system 330, without limitation. In selected embodiments, the historical system data can include any other information of potential relevance to the control system 110, the energy conversion system 300 and or any other component of the energy optimization system 100.

For example, the supplemental control system 130 can use a snap-shot or other selected portions of the historical system data to generate one or more detailed quantitative model parameters for enabling the control system 110 to efficiently establish, maintain and/or adjust the operating region of each energy source 200 and thereby to permit each energy source 200 to continuously operate at (or very near) peak power. The supplemental control system 130 can aggregate the historical system data alone or in combination with current system data, such as current conversion system information currently (or recently) being provided by the energy conversion system 300 and/or current sensor system information currently (or recently) being provided by the source sensor system 120. Stated somewhat differently, the supplemental control system 130 can aggregate the historical system data or can combine the historic system data with the current system data. In selected embodiments, the current system data can include any other information of potential relevance to the control system 110, the energy conversion system 300 and or any other component of the energy optimization system 100.

The control system 110 can provide the historical system data, the current system data and/or any other energy optimization system information to the supplemental control system 130 via the control data signals 139A. In selected embodiments, the supplemental control system 130 can compute the detailed quantitative model parameters for a selected energy source 200 using machine learning or other statistical methods and/or can transmit the detailed quantitative model parameters to the control system 110 via the command signals 139B. The supplemental control system 130 advantageously can utilize the historical system data, the current system data and/or any other energy optimization system information to better compute the detailed quantitative model parameters for the selected energy source 200.

The supplemental control system 130, in selected embodiments, can supplement or otherwise compliment the capabilities of the control system 110 and improve operation of the energy optimization system 100. If the energy optimization system 100 utilizes the quantitative method for computing or otherwise determining optimal (or near-optimal) operating region(s) for the energy source(s) 200 in real time in the manner discussed above, for example, one or more quantitative model parameters of the quantitative models for the energy sources 200 can be computed via the control system 110 and/or the supplemental control system 130. Depending on a particular physical quantitative model, the computational demands may be better served using the supplemental control system 130 with the quantitative model parameters, once computed, being passed to the control system 110.

In the manner discussed in more detail above, the quantitative model parameters can be established, maintained, adjusted or otherwise based upon the conversion system information provided by the energy conversion system 300 via the converter data signals 119A and/or the sensor system information provided by the source sensor system 120 via the sensor data signals 129. In selected embodiments, the supplemental control system 130 can compute the selected characteristics of a relevant energy source 200. If the relevant energy source 200 comprises the photovoltaic device 210 (shown in FIG. 1B), for example, the supplemental control system 130 can compute the reverse saturation current Iₒ and/or the diode ideality factor n, of the photovoltaic device 210 in the manner discussed above with reference to Equations 1 and 2.

System data related to the expected output current I_{OUT_ANTICIPATED} of the photovoltaic device 210, the actual output current I_{OUT_ACTUAL} of the photovoltaic device 210, the output voltage V_{OUT} supplied by the photovoltaic device 210, the temperature T, the reverse saturation current Iₒ and/or the diode ideality factor n of the photovoltaic device 210 can be collected throughout a predetermined period of time and provided to the supplemental control system 130. Using quantitate methods such as gradient descent, revised values for the selected characteristics can be computed from the collected system data. The supplemental control system 130 can transmit the computed values of the selected characteristics to the control system 110, which can use the computed values of the selected characteristics for establishing, maintaining and/or adjusting the operating region of the photovoltaic device 210 and thereby improving the setting of the peak power of the photovoltaic device 210.

The historical system data and/or the current system data for the energy optimization system 100 optionally can be utilized to establish, maintain and/or adjust the quantitative model parameters such that any effects due to aging of the energy source(s) 200 do not substantially affect the computed quantitative model parameters. The computed quantitative model parameters advantageously can facilitate use of the quantitative model for a selected energy source 200 to determine an optimal (or near-optimal) operating region for the selected energy source 200 and, as needed, establish, maintain and/or adjust the pulse width modulation signals and/or a pulse duration modulation signals of the converter control signals 119B provided to the energy conversion system 300 for maximizing or otherwise optimizing the output power 230 that is generated by the energy conversion system 300.

Although shown and described with reference to FIG. 7A as communicating with a single control system 110 for purposes of illustration only, the supplemental control system 130 advantageously can communicate with any predetermined number of control systems 110. By connecting multiple control systems 110 with a common supplemental control system 130, aggregated system information can be monitored by the system user, system data can be combined as appropriate and/or control of the control systems 110 can be improved. Additionally and/or alternatively, if energy sources 200 are geospatially diverse, information regarding potential macro environmental influences can be observed through monitoring of the supplemental control system 130. The user and/or the control systems 110 thereby can exploit the influences.

FIG. 7B illustrates an alternative exemplary embodiment of the energy optimization system 100 of FIG. 7A. Turning to FIG. 7B, the energy conversion system 300 is shown as receiving the supplied energy 220 from the energy source 200, generating the output power 230 based upon the received supplied energy 220 and providing the generated output power 230 to the load 400 in the manner discussed in more detail above with reference to FIGS. 1A-B.

The control system 110 and the supplemental control system 130 can communicate in any conventional manner for exchanging system data, system status and/or system command signals. The control system 110, in selected embodiments, can communicate with the supplemental control system 130 via the input interface system 112 (shown in FIG. 5C) and/or the output interface system 113 (shown in FIG. 5C) of the control system 110 preferably in accordance with a packetized communication protocol and/or in a periodic manner or an aperiodic manner as set forth above with reference to FIG. 7A. The supplemental control system 130 and the control system 110 of FIG. 7B are shown as being configured to communicate via one or more communication cables and/or a conventional wired and/or wireless communication network 140.

Exemplary communication networks 140 can include, but is not limited to, the Internet, an ethernet network, a telephone network, a local area network (LAN), a wide area network (WAN), a campus area network (CAN), personal area network (PAN) and/or a wireless local area network (WLAN), of any kind. Exemplary wireless local area networks include wireless fidelity (Wi-Fi) networks in accordance with Institute of Electrical and Electronics Engineers (IEEE) Standard 802.11, Bluetooth networks in accordance with Institute of Electrical and Electronics Engineers (IEEE) Standard 802.15.1, and/or wireless metropolitan-area networks (MANs), which also are known as WiMax Wireless Broadband, in accordance with IEEE Standard 802.16. The communication network 140, in selected embodiments, can provide an aperiodic communication connection and/or a periodic communication connection between the supplemental control system 130 and the control system 110. Additionally and/or alternatively, the communication network 140 can include a custom cabling system (not shown).

In the manner set forth above with reference to FIG. 7A, the supplemental control system 130 and the control system 110 can exchange the control data signals 139A and/or the command signals 139B. The control data signals 139A, for example, can include the conversion system information provided by the energy conversion system 300 via the converter data signals 119A and/or the sensor system information provided by the source sensor system 120 via the sensor data signals 129.

The supplemental control system 130 thereby can utilize the conversion system information and/or the sensor system information for establishing, maintaining and/or adjusting the parameters of the quantitative model as discussed with reference to FIG. 7A. In selected embodiments, the supplemental control system 130 can compute the selected characteristics of a relevant energy source 200. If the relevant energy source 200 comprises the photovoltaic device 210 (shown in FIG. 1B), for example, the supplemental control system 130 can compute the reverse saturation current Iₒ and/or the diode ideality factor n, of the photovoltaic device 210 in the manner discussed above with reference to Equations 1 and 2. The supplemental control system 130 can transmit the computed quantitative model parameters and any other system data, status and/or command information to the control system 110 via the command signals 139B.

The energy optimization system 100 of FIG. 7B is illustrated as including an optional user computer system 150 for enabling a system operator or other user (not shown) interact or otherwise communicate with the energy optimization system 100. The user computer system 150 can be configured to communicate with the energy optimization system 100 in any conventional manner. As illustrated in FIG. 7B, for example, the user computer system 150 can communicate with the control system 110 and/or the supplemental control system 130 via the communication network 140. The user computer system 150 thereby can exchange data, status and/or command signals with the control system 110 and/or the supplemental control system 130, preferably in accordance with a packetized communication protocol.

Through use of the user computer system 150, the system user advantageously can monitor one or more aspects of command, control, and/or computation for the energy optimization system 100, including the control system 110, the sensor system 120, the supplemental control system 130 and/or the energy conversion system 300. Additionally and/or alternatively, the system user can utilize user computer system 150 to initiate one or more system functions, such as, checking a status of the energy optimization system 100, viewing the current system data and/or the historical system data available from the energy optimization system 100, reviewing information about energy production by the energy optimization system 100, assessing a health of the energy optimization system 100, and/or commencing an appropriate remedial system action, without limitation.

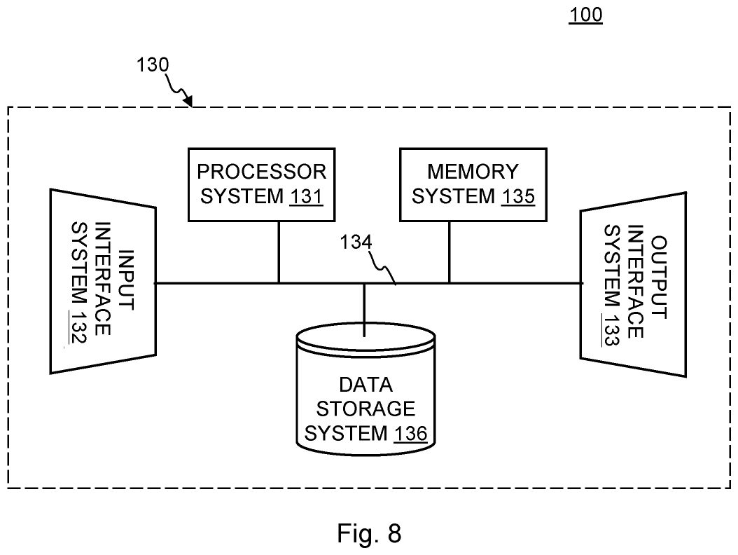

The supplemental control system 130 can be a physical device, or a virtual device hosted in physical device located in the cloud. An exemplary supplemental control system 130 is illustrated in FIG. 8. Turning to FIG. 8, the exemplary supplemental control system 130 is shown as comprising a processor circuit (or system) 131 in communication with an input interface circuit (or system) 132 and/or an output interface circuit (or system) 133. In selected embodiments, the input interface system 132 and the output interface system 133 can be at least partially combined into an input/output (or I/O) interface system. The processor system 131 can comprise any appropriate number and type of conventional computer processing systems, such as one or more microprocessors (μPs), central processing units (CPUs), digital signal processors (DSPs), and/or coder/decoders (CODECs), without limitation.

Additionally and/or alternatively, the supplemental control system 130 can be implemented via a microcontroller (not shown). The microcontroller can include a processor, a random access memory, a non-volatile erasable memory, and/or general purpose registers that can be configured as an input/output interface system. Some microcontrollers, for example, can have an ethernet interface capable of receiving and/or sending network signals. Other related alternate embodiments of the supplemental control system 130 can include a plurality of microcontrollers being configured to distribute a workload of the supplemental control system 130 among the microcontrollers.

The supplemental control system 130 advantageously can utilize the input interface system 132 and/or the output interface system 133 to communicate with, and/or to exchange the control data signals 139A, the command signals 139B, and/or other system data, status and/or command signals with, the control system 110 and/or the user computer system 150. The input interface system 132 and/or the output interface system 133 of the supplemental control system 130 can be configured to communicate with the control system 110 and/or the user computer system 150 via one or more communication cables and/or the communication network 140.

The supplemental control system 130 of FIG. 8 is shown as being configured to communicate with the input interface system 132 and/or the output interface system 133 via an internal communication bus 134. Via the internal communication bus 134, the processor system 131 can exchange data signals, address signals and/or control signals (not shown) with the input interface system 132 and/or the output interface system 133. The processor system 131, in selected embodiments, can manage the signal exchanges and other communications between the supplemental control system 130 and the control system 110 and/or the user computer system 150.

The supplemental control system 130 optionally can include a memory system 135 and/or a data storage system 136. The memory system 135 and/or data storage system 136 can communicate with the processor system 131, the input interface system 132 and/or the output interface system 133 via the internal communication bus 134. The memory system 135 and/or data storage system 136 can comprise any conventional type of volatile and/or non-volatile memory system, such as any suitable electronic, magnetic, and/or optical storage media, without limitation. Exemplary storage media can include one or more static random access memories (SRAMs), dynamic random access memories (DRAMs), electrically-erasable programmable read-only memories (EEPROMs), FLASH memories, hard drives (HDDs), compact disks (CDs), and/or digital video disks (DVDs) of any kind.

In selected embodiments, the memory system 135 and/or data storage system 136 can store data and other information generated by the energy optimization system 100. Exemplary information can include, but is not limited to, the conversion system information provided by the energy conversion system 300 via the converter data signals 119A, the sensor system information provided by the source sensor system 120 via the sensor data signals 129, control information provided by the control system 110 via the control data signals 139A, command information generated by the supplemental control system 130 and provide via the command signals 139B, historical system data for the energy optimization system 100 and/or current system data for the energy optimization system 100. In selected embodiments, the stored information from the energy optimization system 100 can comprise sampled data or other information. Additionally and/or alternatively, the optional memory system 135 and/or data storage system 136 can comprise non-transitory machine-readable storage media upon which software code is stored for execution by the processor system 131. The software code, when executed by the processor system 131, can determine a process or other manner by which the supplemental control system 130 and/or the energy optimization system 100 operate.

The supplemental control system 130, in selected embodiments, can communicate with a supplemental storage system 160 as illustrated in FIG. 7B. In selected embodiments, the supplemental storage system 160 can be provided in the manner discussed above with reference to the memory system 135 and/or data storage system 136 of FIG. 8 and/or can provide back-up or other supplemental storage for the system data and other information stored via the memory system 135 and/or data storage system 136. The supplemental storage system 160 can be configured to communicate with the supplemental control system 130 directly, such as via one or more cables and/or indirectly via one or more intermediate systems, such as the communication network 140.

In addition to establishing, maintaining and/or adjusting the operating region of an energy source 200 for improving the peak power of the energy source 200, the energy optimization system 100 advantageously can enable powerful analytics through the collection of the conversion system information provided by the energy conversion system 300 (shown in FIG. 4) via the converter data signals 119A (shown in FIG. 4) and/or the sensor system information provided by the source sensor system 120 (shown in FIG. 4) via the sensor data signals 129. The conversion system information and/or the sensor system information can be collected and stored, for example, at the control system 110, the supplemental control system 130, and/or the supplemental storage system 160.

In selected embodiments, the collected information, which can include current, voltage, and temperature data, can be used to monitor, analyze, and optimize maintenance and performance of plurality of energy sources 200, such as photovoltaic devices 210 (shown in FIG. 1B). Using the temperature data, the temperature gradient of the photovoltaic devices 210 can be visualized and statistics computed, which can reveal reasons for varying energy production differences. With the current and voltage data, under-performing groups of one or more photovoltaic devices 210 can be identified. The current and voltage data, additionally and/or alternatively, can be utilized to calculate power for each group of photovoltaic devices 210 and statistically compare the calculated power for each device group. Any group of photovoltaic devices 210 that is unfavorably outside of statistical limits thereby can be identified for further investigation and, potentially, repair.

Other types of analysis and optimizations optionally can be computed using the current and voltage data. For example, the point that a group of photovoltaic devices 210 should be cleaned, a significant expense to solar asset owners, can be computed to maximize profits. Using the current and voltage data from uncleaned photovoltaic devices 210, a projection of anticipated solar performance of clean photovoltaic devices 210, as well as cleaning costs, the soiling rate and the optimal time to clean the photovoltaic devices 210 such that profit is maximized can be computed. Other similar analysis and optimizations can be performed by aggregating the conversion system information and/or the sensor system information.

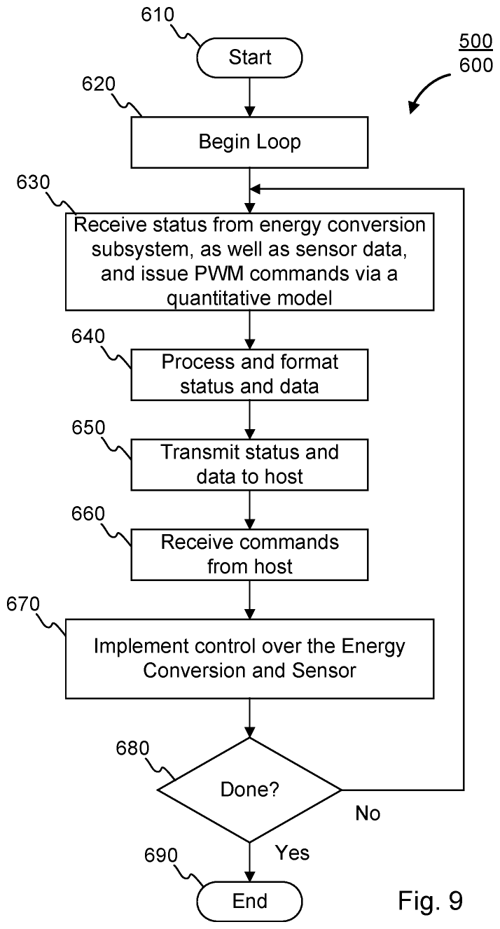

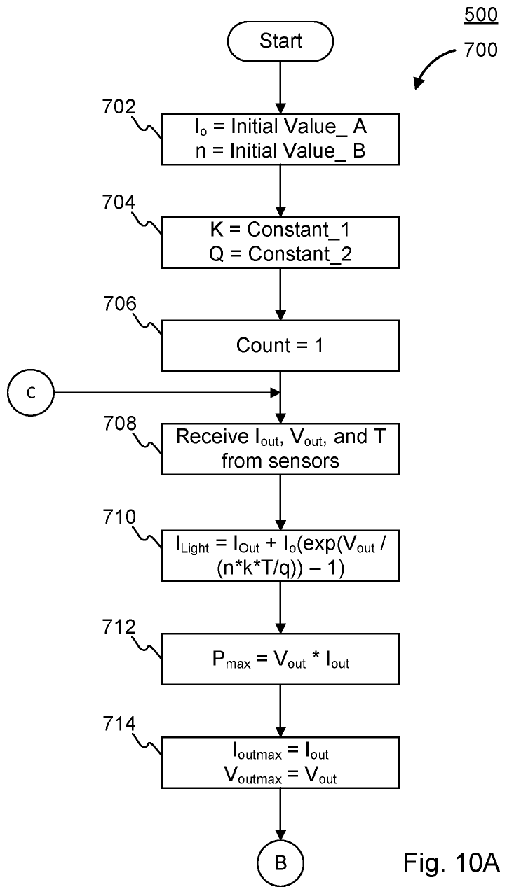

Another exemplary alternative embodiment of the energy optimization method 500 is illustrated in FIG. 9. The energy optimization method 500, for example, can be executed via the energy management processing system. In selected embodiments, the energy optimization method 500 can be performed via the control system 110; whereas, the control system 110 in conjunction with the supplemental control system 130 can perform other embodiments of the energy optimization method 500. Turning to FIG. 9, the energy optimization method 600 can start, at 610. The energy optimization method 600 is shown, at 620, as initiating a processing loop.

The processing loop can include, at 630, receiving the conversion system information provided by the energy conversion system 300 via converter data signals 119A and/or the sensor system information provided by the source sensor system 120 via the sensor data signals 129 (collectively shown in FIG. 4). The energy optimization method 600, at 630, optionally can issue one or more converter control signals 119B. The converter control signals 119B, for example, can be generated and issued based upon the quantitative method discussed in more detail above with regard to FIGS. 4 and 5A-C.

At 640, the conversion system information and/or the sensor system information can be processed and formatted, for example, via the control system 110. The processed and formatted conversion system information and/or sensor system information can be transmitted by the control system 110 to the supplemental control system 130, at 650. The supplemental control system 130 can generate one or more converter control signals 119B based upon the transmitted conversion system information and/or sensor system information and transmit the converter control signals 119B to the control system 110. Based upon the quantitative method discussed in more detail above with regard to FIGS. 4 and 5A-C, one or more quantitative model parameters optionally can be generated by the supplemental control system 130 and transmitted to the control system 110.

The control system 110, at 660, can receive the transmitted converter control signals 119B and/or quantitative model parameters. At 670, the control system 110 can transmit the converter control signals 119B to the energy conversion system 300 to the source sensor system 120. The control system 110 thereby can implement control over the energy conversion system 300 and/or the source sensor system 120. At 680, a determination is made whether the processing loop is complete. If the processing loop is complete, the processing loop is repeated; otherwise, the processing loop and the energy optimization method 600 end, at 690.

In selected embodiments, the energy optimization method 600 can include at least one processor (or hardware) interrupt for the energy management processing system. One or more event-dependent operations, such as receiving the conversion system information and/or the sensor system information, at 630, and/or receiving the transmitted converter control signals 119B and/or quantitative model parameters, at 660, can be performed based on a hardware interrupt. When data associated with an event-dependent operation is received by the energy management processing system, for example, a hardware interrupt can be triggered causing execution of the event-dependent operation and one or more subsequent method operations.

The energy optimization method 600, additionally and/or alternatively, can be implemented using multi-threading. In this embodiment, multiple sets of instructions can be executed in separate (or respective) loops. An exemplary loop can include receiving the conversion system information and/or the sensor system information and/or issuing one or more converter control signals 119B, at 630. When data associated with an event-dependent operation is received by the energy management processing system, the energy optimization method 600 can exit the loop and proceed with one or more subsequent method operations.

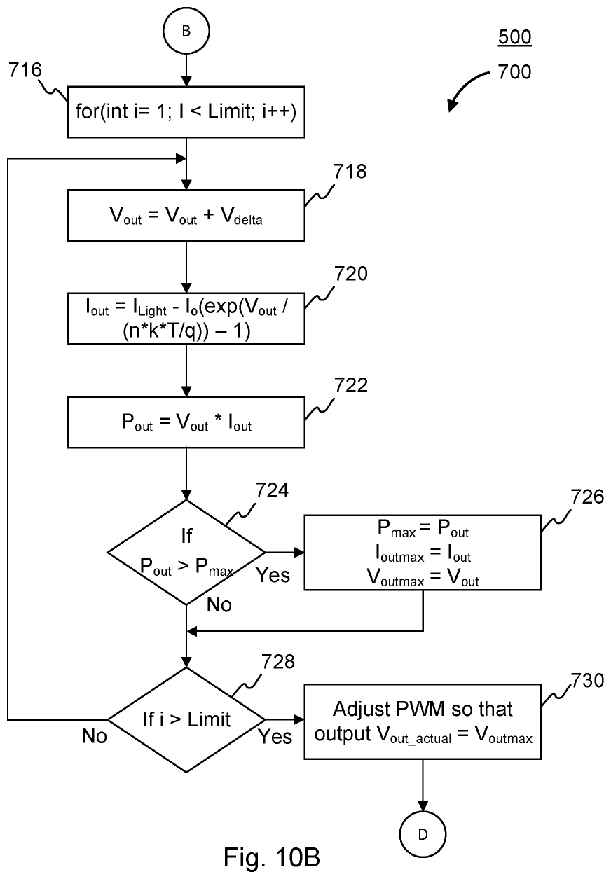

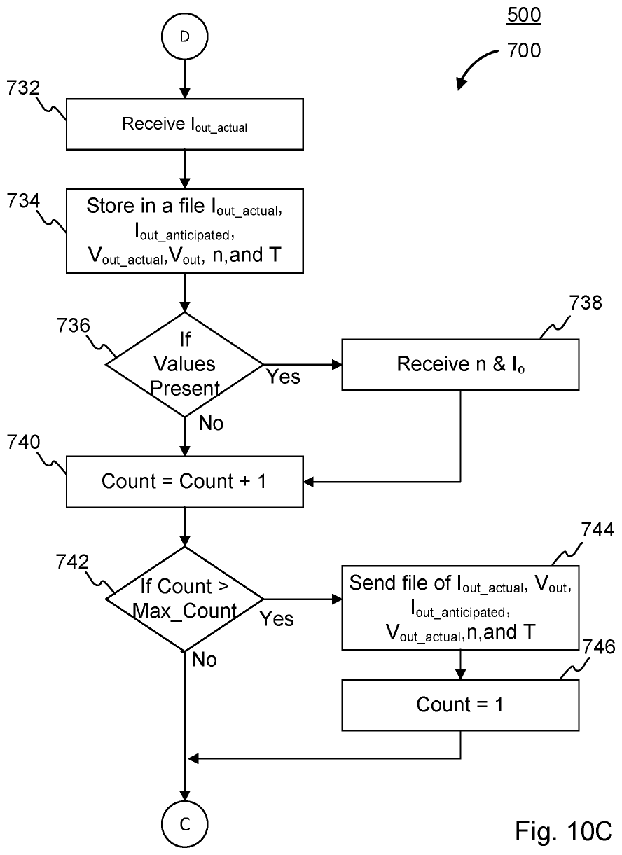

Still another alternative embodiment of the energy optimization method 500 is illustrated in FIGS. 10A-C. Turning to FIGS. 10A-C, the energy optimization method 500 is shown as including an exemplary energy optimization method 700 can establish, maintain and/or adjust the operating region for enabling an energy source 200 to continuously operate at (or very near) peak power regardless of variations in the operating environment 250 of the relevant energy source 200 and/or variations in the operational status of the relevant energy source 200 itself. The energy optimization method 700, for example, can be executed via the energy management processing system.

FIG. 10A shows that the energy optimization method 700 can begin by initializing one or more quantitative model parameters of the quantitative model of the relevant energy source 200. The energy optimization method 700, for example, can initialize the reverse saturation current Io and the diode ideality factor n, at 702. The reverse saturation current Io and the diode ideality factor n, for example, can be set to predetermined initial values. As shown in FIG. 10A, the reverse saturation current Io can be set to an Initial Value A; whereas, the diode ideality factor n can be set to an Initial Value B. The Initial Value A can comprise an initial estimated value for the reverse saturation current Io, and/or the Initial Value B can comprise an initial estimated value for the diode ideality factor n.

Additionally and/or alternatively, the energy optimization method 700 can initialize the Boltzmann constant K and the elementary charge of an electron q, at 704. The Boltzmann constant K and the elementary charge of an electron q, for example, can be set to predetermined values. As shown in FIG. 10A, the Boltzmann constant K can be set to a Constant 1; whereas, the elementary charge of an electron q can be set to a Constant 2. A first loop count optionally can be initialized, at 706. The first loop count is illustrated in FIG. 10A as being set to a first loop count value of one.

Initial measured values for the output current I_{OUT} supplied by the relevant energy source 200, the output voltage V_{OUT} supplied by the relevant energy source 200 and the temperature T in Kelvin can be received, at 708, from the sensor systems 120 disposed within the operating environment 250. For example, the initial measured value of the output current I_{OUT} can be provided via the current sensor subsystems 124 (shown in FIG. 5B); whereas, the initial measured value of the output voltage V_{OUT} can be provided via the voltage sensor subsystems 123 (shown in FIG. 5B). An initial value for the current I_{LIGHT} generated from incident light can be determined, at 710. The initial value for the current I_{LIGHT}, for example, can be determined based upon the quantitative model for the relevant energy source 200. If the relevant energy source 200 comprises a photovoltaic device 210 (shown in FIG. 1B), the initial value for the current I_{LIGHT} generated from incident light can be determined based upon the quantitative model for the photovoltaic device 210 in accordance with Equation 2 as set forth above.

At 712, an estimated value of a maximum output power P_{MAX} for the photovoltaic device 210 can be determined as a product of the initial measured value of output voltage V_{OUT} supplied by the photovoltaic device 210 and the initial measured value of the output current I_{OUT} supplied by the photovoltaic device 210. An estimated value of the maximum output voltage V_{OUTMAX} of the photovoltaic device 210 can be estimated as being the initial measured value of the output voltage V_{OUT}; whereas, an estimated value of the maximum output current I_{OUTMAX} of the photovoltaic device 210 can be estimated as being the measured value of the output current I_{OUT}. In selected embodiments, the estimated values of the maximum output power P_{MAX}, the maximum output voltage V_{OUTMAX} and/or the maximum output current I_{OUTMAX} can be associated with a maximum peak power of the photovoltaic device 210.

As shown in FIG. 10B, a second loop can be initiated, at 716. The second loop can be associated with a second loop count i that can be initiated with an initial second loop count value of one. The second loop can be set with a predetermined number Limit of iterations. The predetermined number Limit of iterations can comprise any suitable integer value.

Within the second loop, an estimated value of output voltage V_{OUT} can be determined, at 718. The estimated value of output voltage V_{OUT} can comprise an incremented value of the initial measured value of the output voltage V_{OUT}. As illustrated in FIGS. 10A-C, for example, the estimated value of output voltage V_{OUT} can comprise a sum of the initial measured value of the output voltage V_{OUT} and an incremental voltage V_{DELTA}. The incremental voltage V_{DELTA} can comprise any suitable incremental voltage value.

The energy optimization method 700 advantageously can utilize the quantitative method. At 720, for example, the energy optimization method 700 can determine an updated value for the output current I_{OUT} based upon the updated value of output voltage V_{OUT}, as determined at 718. The output current I_{OUT}, for example, can be calculated based upon Equation 1 above.

At 722, an updated value of the maximum output power P_{MAX} for the photovoltaic device 210 can be determined as a product of the updated value of output voltage V_{OUT}, as determined at 718, and an expected value for the output current I_{OUT}, as determined at 720. The updated value of the maximum output power P_{MAX} can be compared, at 724, with the estimated value of the maximum output power P_{MAX}, as determined at 712. If the updated value of the maximum output power P_{MAX} is greater than the estimated value of the maximum output power P_{MAX}, the estimated value of the maximum output power P_{MAX} can be updated to be equal to the updated value of the maximum output power P_{MAX}, as determined at 726.

Additionally and/or alternatively, the estimated value of the maximum output voltage V_{OUTMAX} can be updated to be equal to the updated value of output voltage V_{OUT}, as determined at 718, and/or the estimated value of the maximum output current I_{OUTMAX} can be updated to be equal to the updated value for the output current I_{OUT}, as determined at 720, if the updated value of the maximum output power P_{MAX} is greater than the estimated value of the maximum output power P_{MAX}. Otherwise, if the updated value of the maximum output power P_{MAX} is less than (or equal to) the estimated value of the maximum output power P_{MAX}, the estimated values of the maximum output power P_{MAX}, the maximum output voltage V_{OUTMAX} and/or the maximum output current I_{OUTMAX} can remain unchanged.

The second loop count i can be compared with the predetermined number Limit of iterations, at 728. If the second loop count i is less than (or equal to) the predetermined number Limit of iterations, the second loop count i can be increased by one or otherwise incremented, and the second loop can repeat by, for example, again determining an updated value of output voltage V_{OUT}, at 718. If the second loop count i is greater the predetermined number Limit of iterations, the second loop can terminate, and the estimated values of the maximum output power P_{MAX}, the maximum output voltage V_{OUTMAX} and/or the maximum output current I_{OUTMAX} can be deemed to be accurate estimated.

The energy optimization method 700 can utilize the updated value of output voltage V_{OUT}, as determined at 718, to adjust a duty cycle, a pulse width and/or a pulse duration of the converter control signal 119B so that the output voltage V_{OUT} supplied by the photovoltaic device 210 is equal to the maximum output voltage V_{OUTMAX}. In other words, the duty cycle, the pulse width and/or the pulse duration of the converter control signal 119B can be adjusted such that an updated measured value of the output voltage V_{OUT} supplied by the photovoltaic device 210 is equal to the current value of the maximum output voltage V_{OUTMAX}. With the duty cycle, the pulse width and/or the pulse duration of the converter control signal 119B can be adjusted, an updated measured value for the output current I_{OUT} supplied by the relevant energy source 200 can be received, at 732, from the sensor systems 120 as illustrated in FIG. 10C.

In selected embodiments, one or more values for selected quantitative model parameters of the quantitative model of the photovoltaic device 210 can be stored as stored quantitative model parameters, at 734. FIG. 10B shows that the selected quantitative model parameters can include the updated measured value for the output current I_{OUT}, the updated value of the maximum output current I_{OUTMAX}, the updated measured value of the output voltage V_{OUT}, the updated value of the maximum output voltage V_{OUTMAX}, the received value for the diode ideality factor n, the received value for the reverse saturation current Io and/or the received value of the temperature T in Kelvin. A determination can be made, at 736, whether an updated value for one or more characteristics, such as the reverse saturation current Iₒ and/or the diode ideality factor n, of the photovoltaic device 210 is available. The updated value for the one or more characteristics of the photovoltaic device 210 can be received, at 738. The value for any other characteristic of the photovoltaic device 210 can remain unchanged.

The first loop count can be increased by one or otherwise incremented, at 740. The first loop count can be compared with a predetermined maximum count number, at 728. If the first loop count is greater than the predetermined maximum count number, the stored quantitative model parameters, as stored at 734, can be transmitted. The supplemental control system 130, for example, can transmit the stored quantitative model parameters to the control system 110. At 746, the first loop count can be re-initialized to one. If the first loop count is less than (or equal to) the predetermined maximum count number, the first loop can repeat by, for example, again receiving measured values for the output current I_{OUT}, the output voltage V_{OUT} and the temperature T in Kelvin from the sensor systems 120, at 708.

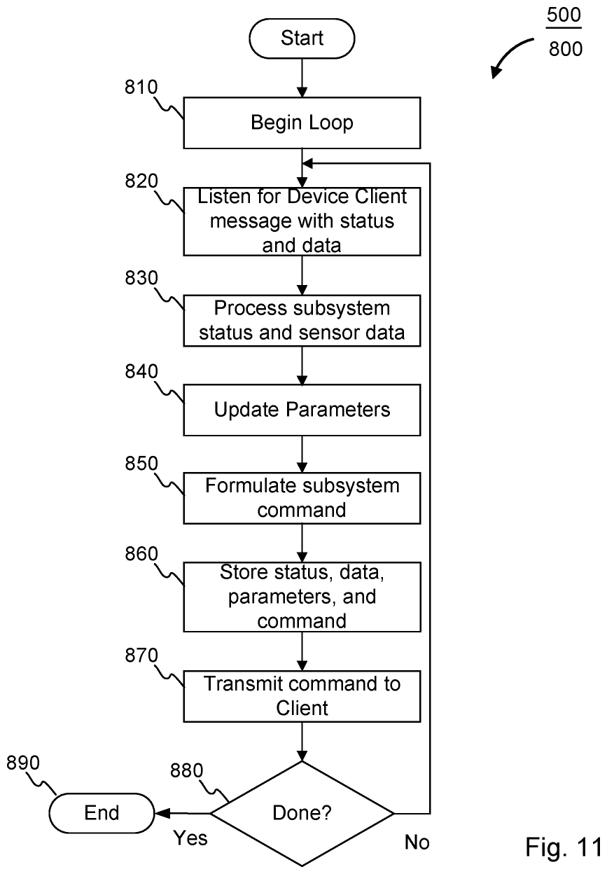

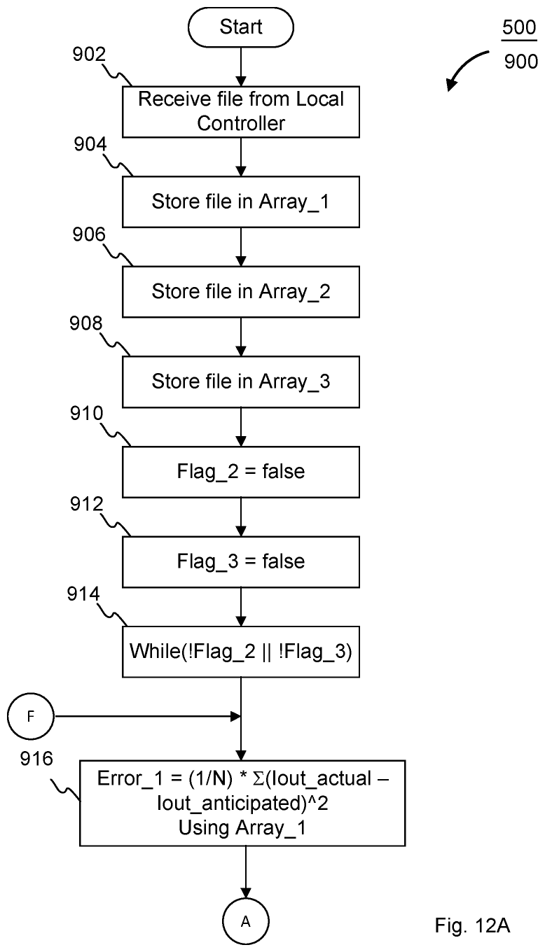

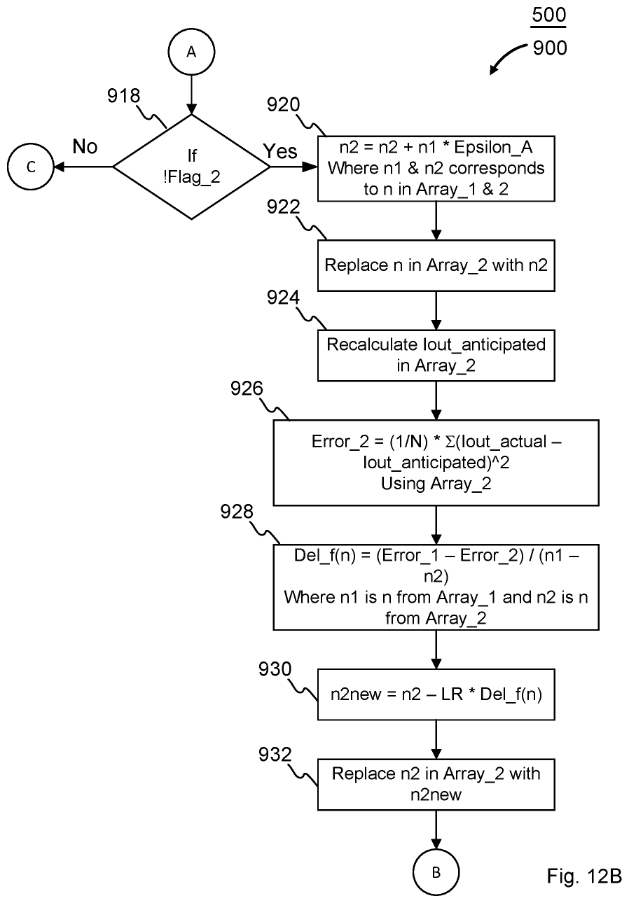

FIG. 11 illustrates a first interaction method 800 by which the supplemental control system 130 (shown in FIGS. 7A-B) interacts with the control system 110 (shown in FIGS. 7A-B). The first interaction method 800 is shown, at 810, as initiating a processing loop. The processing loop can include, at 820, the supplemental control system 130 listening for a device client message with the conversion system information provided by the energy conversion system 300 (shown in FIGS. 7A-B), the sensor system information provided by the source sensor system 120 (shown in FIGS. 7A-B), and/or other system status and data information available from the control system 110. The supplemental control system 130, for example, can receive the conversion system information, the sensor system information and/or other system status and data information from the control system 110 via one or more control data signals 139A.

Upon receiving the system status and data information, the supplemental control system 130 can process the received system status and data information, at 830, and update one or more quantitative model parameters of the quantitative model of the relevant energy source 200 (shown in FIGS. 7A-B), at 840. The supplemental control system 130, for example, can update the quantitative model parameters based upon the received system status and data information. At 850, the supplemental control system 130 can formulate at least one command based upon the quantitative model parameters. In selected embodiments, the received system status and data information, the update the quantitative model parameters and/or the formulated command can be stored, at 860, and/or the command and/or the quantitative model parameters can be transmitted to the control system 110, at 870, via one or more command signals 139B. At 880, a decision can be made regarding whether to repeat the processing loop, or to end the first interaction method 800, at 890.

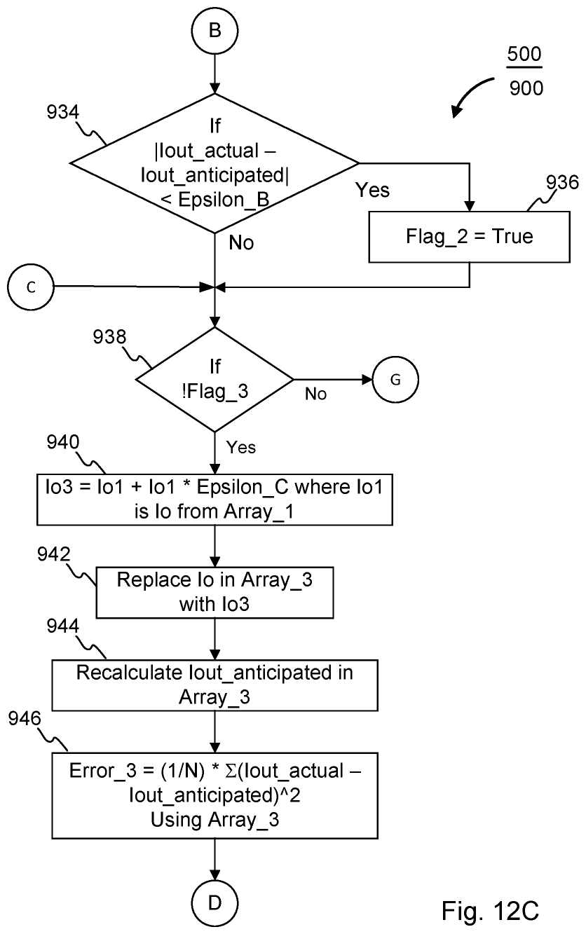

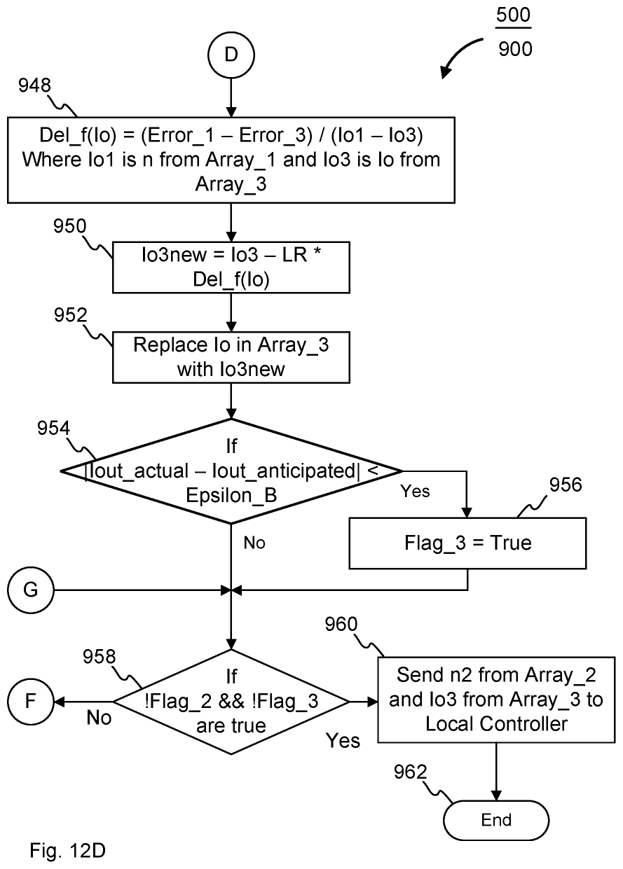

An exemplary machine learning method 900 is illustrated in FIGS. 12A-D. The machine learning method 900 can be utilized, for example, update one or more quantitative model parameters of the quantitative model of the relevant energy source 200, at 840 (as shown in FIG. 11), and, in selected embodiments, can be implemented via the supplemental control system 130. Turning to FIG. 12A, the machine learning method 900 can include, at 902, receiving a file from the control system 110.

The received file can include updated values for the selected quantitative model parameters in the manner discussed above with reference to the energy optimization method 700 of FIGS. 10A-C and the first interaction method 800 of FIG. 11. The updated values of the received file can include, but are not limited to, the updated measured value for the output current I_{OUT}, the updated value of the maximum output current I_{OUTMAX}, the updated measured value of the output voltage V_{OUT}, the updated value of the maximum output voltage V_{OUTMAX}, the received value for the diode ideality factor n, the received value for the reverse saturation current Io and/or the received value of the temperature T in Kelvin in the manner discussed above.

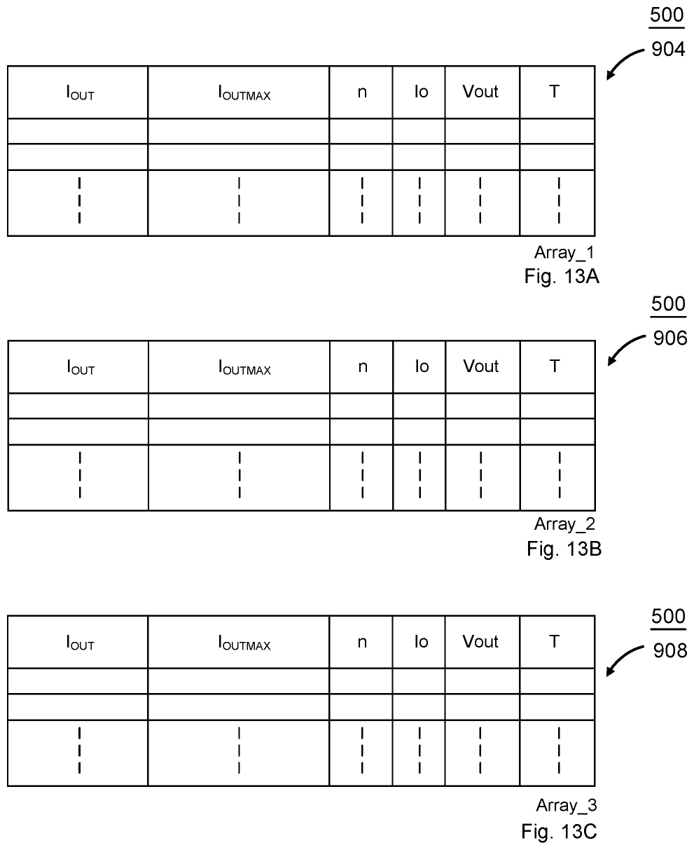

As shown in FIG. 12A, the received file can be stored in a first Array 1, at 904, stored in a second Array 2, at 906, and/or stored in a third Array 3, at 908. An exemplary structure of the first Array 1 is shown in FIG. 13A. The first Array 1 of FIG. 13A is illustrated as including values of the output current I_{OUT}, values of the maximum output current I_{OUTMAX}, values of the diode ideality factor n, values of the reverse saturation current Iₒ, values of the output voltage V_{OUT}, and values of the temperature T. Additional rows of values can be stored in the first Array 1, for example, pursuant to the update one or more quantitative model parameters of the quantitative model of the relevant energy source 200, at 840, during each iteration (or repeat) of the processing loop in the first interaction method 800 of FIG. 11.

Exemplary structures of the second Array 2 and the third Array 3 are shown in FIG. 13B and FIG. 13C, respectively. Like the first Array 1, the second Array 2 and the third Array 3 are illustrated as including values of the output current I_{OUT}, values of the maximum output current I_{OUTMAX}, values of the diode ideality factor n, values of the reverse saturation current Io, values of the output voltage V_{OUT}, and values of the temperature T. In selected embodiments, additional rows of values can be stored in the second Array 2 and/or the third Array 3 pursuant to the update one or more quantitative model parameters of the quantitative model of the relevant energy source 200, at 840, during each iteration (or repeat) of the processing loop in the first interaction method 800 of FIG. 11.

A first flag, Flag 2, can be set to false, at 910, and a second flag, Flag 3, can be set to false, at 912. The first flag, Flag 2, can become true when an update of the diode ideality factor n, such as through a machine learning process, is complete. Additionally and/or alternatively, second flag, Flag 3, can become true when an update of the reverse saturation current Iₒ, such as through a machine learning process, is complete.

As shown in FIG. 12A, a processing loop can be initiated, at 914, via a while statement conditioned on the first flag, Flag 2, and the second flag, Flag 3, both being false. A first error, Error 1, can be computed, at 916. The first error, Error 1, can be an average mean squared value formed by a difference between a value of the output current I_{OUT} and a value of the maximum output current I_{OUTMAX} stored in the first Array 1 and based upon the associated stored values of the diode ideality factor n, the reverse saturation current Io, the output voltage V_{OUT} and the temperature T.

A status of the first flag, Flag 2, can be examined, at 918, as shown in FIG. 12B. The first flag, Flag 2, can become true when convergence on a new value for the diode ideality factor n is complete. If the first flag, Flag 2, is false, the value for the diode ideality factor n requires further refinement. A new value n2 of the diode ideality factor n can be computed, at 920. The new value n2 of the diode ideality factor n can be computed, for example, by adding the product of the value of the diode ideality factor n from the first Array 1 and a predetermined multiplication factor Epsilon A to the value of the diode ideality factor n from the second Array 2. The computed new value n2 of the diode ideality factor n can be stored, at 922, in the second Array 2.

A new value of the maximum output current I_{OUTMAX} can be computed, at 922, based upon the new value n2 of the diode ideality factor n. If the relevant energy source 200 comprises a photovoltaic device 210 (shown in FIG. 1B), the new value of the maximum output current I_{OUTMAX} can be computed in accordance with Equation 1 above using the new value n2 of the diode ideality factor n. The computed new value of the maximum output current I_{OUTMAX} can be stored in the second Array 2.

A second error, Error 2, can be computed, at 926. The second error, Error 2, for example, can be computed using values from the second Array 2 in the manner illustrated in FIG. 12B. In selected embodiments, the second error, Error 2, can be based on an adjusted value for the diode ideality factor n that can be formed by adding a small, predetermined value, delta, to the diode ideality factor n stored in the first Array 1. The second error, Error 2, can comprise an average mean squared error between the value of the output current I_{OUT} and the value of the maximum output current I_{OUTMAX}.

At 928, a first gradient (or derivative), Del f(n), can be formed. The first gradient, Del f(n), can be calculated as a difference between the first error, Error 1, and the second error, Error 2, divided by a difference between the diode ideality factor n stored in the first Array 1 and the diode ideality factor n stored in the second Array 2. In selected embodiments, the first gradient, Del f(n), can reflect a change in error with respect to the change in the diode ideality factor n.

The machine learning method 900, at 930, can compute a new value, n2new, for the diode ideality factor n. As illustrated in FIG. 12B, the new value, n2new, can be computed by subtracting a product of a learn rate (or LR) and the previously-calculated first gradient, Del f(n), from the value of the diode ideality factor n stored in the second Array 2. The Learn Rate can be a value that is less than one but greater than zero and can comprise a balance between the number of computation steps and rate of convergence on the diode ideality factor n. The computed new value, n2new, for the diode ideality factor n can be stored in the second Array 2, at 932, as a new value for the diode ideality factor n.

Turning to FIG. 12C, a determination can be made, at 934, regarding whether convergence of the value of the diode ideality factor n has been reached. As shown in FIG. 12C, the determination can be based upon a comparison of a difference between a value of the output current I_{OUT} and a value of the maximum output current I_{OUTMAX} and a predetermined convergence factor Epsilon B. The convergence factor Epsilon B, in selected embodiments, can be determined based on an acceptable error between an ideal value for the diode ideality factor n and the updated value for the diode ideality factor n. The smaller the acceptable error, the greater the number of computations. If an absolute value of the difference between the value of the output current I_{OUT} and the value of the maximum output current I_{OUTMAX} is less than the convergence factor Epsilon B, convergence can be determined to have been obtained, and, at 936, the first flag, Flag 2, can be set to true.

If the difference between the value of the output current I_{OUT} and the value of the maximum output current I_{OUTMAX} is greater than a convergence factor Epsilon B, a current status of the second flag, Flag 3, can be examined, at 938. If the second flag, Flag 3, is true, a new value Io3 for the reverse saturation current Io can be computed, at 940, as a sum of the value Io1 of the reverse saturation current Io stored in the first Array 1 and a product of the value Io1 and a predetermined adjustment factor Epsilon C. The computed new value Io3 for the reverse saturation current Io can be stored in the third Array 3, at 942, as a new value for the diode ideality factor n.

A new value of the maximum output current I_{OUTMAX} can be computed, at 944, based upon the computed new value Io3 for the reverse saturation current Io. The value of the maximum output current I_{OUTMAX}, in other words, can be recalculated based upon the computed new value Io3 for the reverse saturation current Io. If the relevant energy source 200 comprises a photovoltaic device 210, the new value of the maximum output current I_{OUTMAX} can be computed in accordance with Equation 1 above using the computed new value Io3 for the reverse saturation current Io. The computed new value of the maximum output current I_{OUTMAX} can be stored in the third Array 3.

At 946, a third error, Error 3, can be computed. The third error, Error 3, can comprise the average mean squared error between the value of the output current I_{OUT} and the value of the maximum output current I_{OUTMAX} in the third Array 3 as shown in FIG. 12C. FIG. 12D illustrates that a second gradient (or derivative), Del f(Io), can be formed, at 948. The second gradient, Del f(Io), can be calculated as a difference between the first error, Error 1, and the third error, Error 3, divided by a difference between the value Io1 of the reverse saturation current Io stored in the first Array 1 and the value Io3 for the reverse saturation current Io stored in the third Array 3. In selected embodiments, the second gradient, Del f(Io), can reflect a change in error with respect to the change in the reverse saturation current Io.

The machine learning method 900, at 950, can compute a new value, Io3new, for the reverse saturation current Io. As illustrated in FIG. 12D, the new value, Io3new, can be computed by subtracting a product of the learn rate and the previously-calculated second gradient, Del f(Io), from the value Io3 for the reverse saturation current Io stored in the third Array 3. As set forth above, the Learn Rate can be a value that is less than one but greater than zero and/or can comprise a balance between the number of computation steps and rate of convergence on the reverse saturation current Io. The computed new value, Io3new, for the reverse saturation current Io can be stored in the second Array 2, at 952, as a new value for the reverse saturation current Io.

A determination can be made, at 954, regarding whether convergence of the value of the reverse saturation current Io has been reached. As shown in FIG. 12D, the determination can be based upon a comparison of a difference between a value of the output current I_{OUT} and a value of the maximum output current I_{OUTMAX} and the previously-determined convergence factor Epsilon B. In the manner discussed in more detail above, the convergence factor Epsilon B can be determined based on an acceptable error between an ideal value for the reverse saturation current Io and the updated value for the reverse saturation current Io. If an absolute value of the difference between the value of the output current I_{OUT} and the value of the maximum output current I_{OUTMAX} is less than the convergence factor Epsilon B, convergence can be determined to have been obtained, and, at 956, the second flag, Flag 3, can be set to true.

A current status of the first flag, Flag 2, and of the second flag, Flag 3, can be examined, at 958. If both the first flag, Flag 2, and the second flag, Flag 3, are set to true, the values of the diode ideality factor n and the reverse saturation current Io can be deemed to have converged. The value n2 of the diode ideality factor n stored in the second Array 2 and the value Io3 for the reverse saturation current Io stored in the third Array 3 therefore can be provided, at 960, to the control system 110, and the machine learning method 900 can end, at 960. Once the machine learning method 900 ends, the update of the quantitative model parameters of the quantitative model is complete. Alternatively, if both the first flag, Flag 2, and the second flag, Flag 3, not are set to false, the values of the diode ideality factor n and the reverse saturation current Io cannot be deemed to have converged. The machine learning method 900 thus can continue, for example, by computing the first error, Error 1, at 916 as illustrated in FIG. 12A.

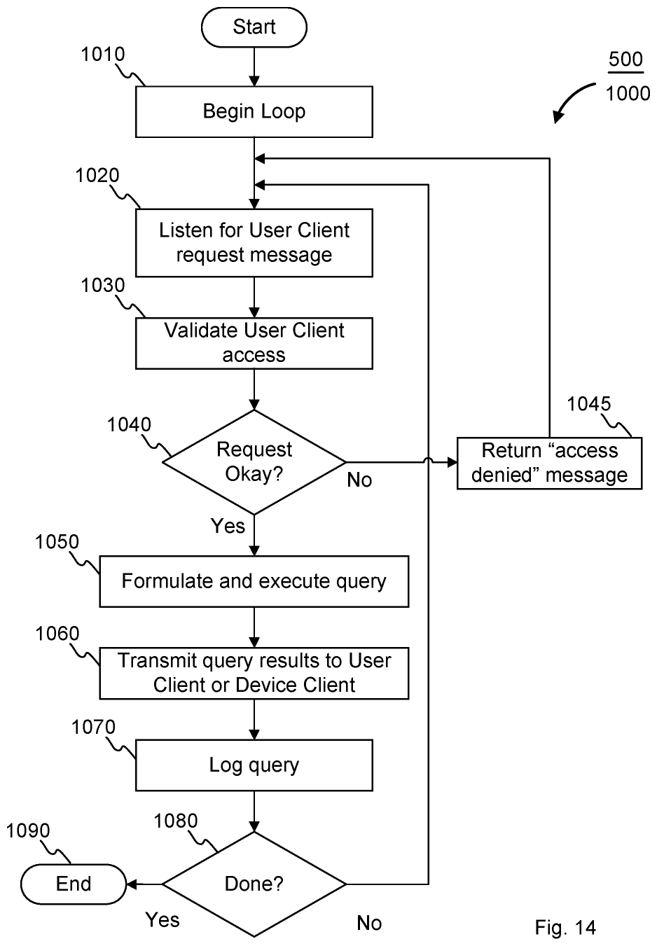

An embodiment of a second interaction method 1000 for the supplemental control system 130 is shown in FIG. 14. The supplemental control system 130 enables the supplemental control system 130 to communicate with the user computer system 150 (shown in FIG. 7B). Turning to FIG. 14, the second interaction method 1000, at 1010, can include initiating a processing loop. The processing loop can include, at 1020, the supplemental control system 130 (shown in FIGS. 7A-B) listening for a user client message request. If a user client message request is received, the supplemental control system 130 can validate the received user client message request, at 1030.

At 1040, the received user client message request can be deemed acceptable or unacceptable. If the received user client message request is deemed unacceptable or otherwise fails, the second interaction method 1000 can return a failure message, at 1045, and can reinitiate the processing loop. The received user client message request can be deemed unacceptable, for example, if the user attempting to access the energy optimization system 100 via the user computer system 150 is not part of an approved list of users. Otherwise, the received user client message request can be deemed acceptable if, for example, validated by a list of approved users, and the processing loop can proceed.

A query can be formulated and executed, at 1050. The query can be executed by the supplemental control system 130 to provide results. The results of the query can be transmitted, at 1060, to the user computer system 150. The query can be logged, at 1070. At 1080, a decision can be made regarding whether to repeat the processing loop, or to end the second interaction method 1000, at 1090.

In selected embodiments, the first interaction method 800 of FIG. 11 and the second interaction method 1000 of FIG. 14 can simultaneously operate. The first interaction method 800 of FIG. 11 and the second interaction method 1000 optionally can be a part of a single multi-threaded program or method. Additionally and/or alternatively, the first interaction method 800 of FIG. 11 and the second interaction method 1000 can comprise separate programs or methods that can operate simultaneously through a common operating system.

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for optimizing an efficiency of an energy source being disposed within an operating environment and supplying energy to an energy conversion circuit for generating output power based upon the supplied energy, comprising:
receiving conversion system information from the energy conversion circuit and sensor system information from one or more sensor circuits within the operating environment;
calculating one or more quantitative model parameters of a quantitative model for predicting an operational behavior of the energy source based upon the received conversion system information and the received sensor system information;
generating a converter control signal for establishing an optimal operating region of the energy source based upon the calculated quantitative model parameters; and
transmitting the converter control signal to the energy conversion system,
wherein the energy conversion circuit sets the supplied energy from the energy source based upon the converter control signal to establish a first operating region for enabling the energy source to operate at a peak power.

2. The method of claim 1, wherein said receiving the conversion system information and the sensor system information comprises receiving the conversion system information and the sensor system information in real time, wherein said calculating the quantitative model parameters of the quantitative model comprises calculating the quantitative model parameters of the quantitative model in real time, wherein said generating the converter control signal comprises generating the converter control signal in real time, wherein said transmitting the converter control signal comprises transmitting the converter control signal to the energy conversion system in real time, and wherein the energy conversion circuit sets the supplied energy from the energy source in real time.

3. The method of claim 1, wherein said receiving the conversion system information and the sensor system information comprises receiving current conversion system information from the energy conversion circuit and current sensor system information from one or more sensor circuits within the operating environment.

4. The method of claim 3, further comprising storing the current conversion system information as historic conversion system information, storing the current sensor system information as historic sensor system information, storing the optimal operating region as historic operating region information or a combination thereof.

5. The method of claim 4, further comprising:
receiving updated conversion system information from the energy conversion circuit and updated sensor system information from one or more sensor circuits within the operating environment;
calculating one or more updated quantitative model parameters of the quantitative model based upon the received updated conversion system information and the received updated sensor system information;
generating an updated converter control signal for establishing an updated optimal operating region of the energy source based upon the calculated updated quantitative model parameters; and
transmitting the updated converter control signal to the energy conversion system,
wherein the energy conversion circuit adjusts the supplied energy from the energy source based upon the updated converter control signal to establish a second operating region for enabling the energy source to continue to operate at the peak efficiency.

6. The method of claim 5, further comprising storing the updated conversion system information among the historic conversion system information, storing the updated sensor system information among the historic sensor system information, storing the updated optimal operating region among the historic operating region information or a combination thereof.

7. The method of claim 6, further comprising receiving a system user request and presenting the updated conversion system information, the historic conversion system information, the updated sensor system information, the historic sensor system information, the updated optimal operating region, the historic operating region information in response to the system user request or a combination thereof.

8. The method of claim 5, wherein the energy conversion circuit continuously adjusts the operating region the energy source to compensate for any environmental changes in the operating environment, any operational changes to the energy source or both.

9. The method of claim 5, further comprising retrieving the stored historic conversion system information, the historic sensor system information, the historic operating region information or a combination thereof, wherein said calculating the updated quantitative model parameters includes using the stored historic conversion system information, the stored historic sensor system information, the historic operating region information or a combination thereof to calculate the updated quantitative model parameters.

10. The method of claim 1, wherein the sensor system information includes an output voltage measurement data signal from a voltage sensor circuit for measuring an output voltage generated by the energy source, an output current measurement data signal from a current sensor circuit for measuring an output current generated by the energy source or both.

11. The method of claim 1, wherein the energy source comprises a photovoltaic device, and wherein the sensor system information includes an internal temperature data signal from an internal temperature sensor circuit for measuring a temperature inside the photovoltaic device, an external temperature data signal from an external temperature sensor circuit for measuring a temperature of the operating environment outside the photovoltaic device or both.

12. The method of claim 11, wherein the sensor system information further comprises an image data signal from an image sensor circuit for capturing an image of the photovoltaic device and an irradiance data signal from a pyranometer sensor circuit for measuring irradiance at the photovoltaic device.

13. The method of claim 12, wherein the image sensor circuit is activated for capturing the image when the measured temperature inside the photovoltaic device is greater than or equal to the predetermined energy source threshold temperature, when measured temperature of the operating environment is greater than or equal to the predetermined operating environment threshold temperature or both.

14. The method of claim 1,
wherein the energy source comprises a wind energy source, and wherein the sensor system information includes a wind speed data signal from an anemometer sensor circuit for measuring wind speed at the wind energy source, a torque data signal from a torque sensor circuit for measuring a torque generated by the wind energy source, an angular speed signal from an angular speed sensor circuit for measuring an angular speed of the wind energy source or a combination thereof, or
wherein the energy source comprises a tidal energy source, and wherein the sensor system information includes a water level data signal from a water level sensor circuit for measuring water level.

15. The method of claim 1, wherein said transmitting the converter control signal includes transmitting the converter control signal to a direct current-to-direct current (DC-to-DC) conversion circuit, a direct current-to-alternating current (DC-to-AC) inverter circuit of the energy conversion system or both.

16. The method of claim 15, wherein said generating the converter control signal includes generating the converter control signal with a duty cycle, a pulse width or a pulse duration, and wherein said transmitting the converter control signal includes transmitting the converter control signal to a pulse width modulation circuit or a pulse duration modulation circuit of the direct current-to-direct current (DC-to-DC) conversion circuit.

17. The method of claim 16, wherein said generating the converter control signal includes adjusting the duty cycle, the pulse width or the pulse duration of the converter control signal, wherein said transmitting the converter control signal includes transmitting the adjusted converter control signal to the energy conversion system, and wherein the direct current-to-direct current (DC-to-DC) conversion circuit adjusts the supplied energy from the energy source based upon the adjusted converter control signal.

18. The method of claim 1,
wherein said receiving the conversion system information and the sensor system information comprises receiving the conversion system information and the sensor system information at a control circuit and transmitting the conversion system information and the sensor system information from the control circuit to a supplemental control circuit,
wherein said calculating the one or more quantitative model parameters comprises receiving the transmitted conversion system information and the transmitted sensor system information at the supplemental control circuit, calculating the one or more quantitative model parameters of the quantitative model at the supplemental control circuit based upon the transmitted conversion system information and the transmitted sensor system information and transmitting the calculated quantitative model parameters from the supplemental control circuit to the control circuit,
wherein said generating the converter control signal comprises generating the converter control signal at the control circuit based upon the received calculated quantitative model parameters, and
wherein said transmitting the converter control signal includes transmitting the converter control signal from the control circuit to the energy conversion system.

19. A computer program product for optimizing an efficiency of an energy source being disposed within an operating environment and supplying energy to an energy conversion circuit for generating output power based upon the supplied energy, the computer program product being encoded on one or more non-transitory machine-readable storage media and comprising:
instruction for receiving conversion system information from the energy conversion circuit and sensor system information from one or more sensor circuits within the operating environment;
instruction for calculating one or more quantitative model parameters of a quantitative model for predicting an operational behavior of the energy source based upon the received conversion system information and the received sensor system information;
instruction for generating a converter control signal for establishing an optimal operating region of the energy source based upon the calculated quantitative model parameters; and
instruction for transmitting the converter control signal to the energy conversion system,
wherein the energy conversion circuit sets the supplied energy from the energy source based upon the converter control signal to establish a first operating region for enabling the energy source to operate at a peak power.

20. A system for optimizing an efficiency of an energy source being disposed within an operating environment and supplying energy to an energy conversion circuit for generating output power based upon the supplied energy, comprising:
one or more sensor circuits being disposed within the operating environment; and
a processing circuit for receiving conversion system information from the energy conversion circuit and sensor system information from said sensor circuits, calculating one or more quantitative model parameters of a quantitative model for predicting an operational behavior of the energy source based upon the received conversion system information and the received sensor system information, generating a converter control signal for establishing an optimal operating region of the energy source based upon the calculated quantitative model parameters and transmitting the converter control signal to the energy conversion system,
wherein the energy conversion circuit sets the supplied energy from the energy source based upon the converter control signal to establish a first operating region for enabling the energy source to operate at a peak power.
